(19) United States
(12) Patent Application Publication
(10) Pub. No.: US 2011/0124532 A1
(43) Pub. Date: May 26, 2011

(54) FLUORINATED ETHER SILANES AND METHODS OF USING THE SAME

(76) Inventors: Andreas R. Maurer, Langenneufnach (DE); Harald Kaspar, Burgkirchen (DE); Kai H. Lochhaas, Neuoetting (DE); Michael Juergens, Neuoetting (DE); Michael S. Terrazas, Prescott, WI (US); Miguel A. Guerra, Woodbury, MN (US); Rudolf J. Dams, Antwerp (BE); Tilman C. Zipplies, Burghausen (DE); Zai-Ming Qiu, Woodbury, MN (US); Klaus Hintzer, Kastl (DE); Werner Schwertfeger, Langgons (DE)

(21) Appl. No.: 13/054,579

(22) PCT Filed: Jul. 16, 2009
(86) PCT No.: PCT/US2009/050810

§ 371 Date: Jan. 18, 2011

Related U.S. Application Data
(60) Provisional application No. 61/081,936, filed on Jul. 18, 2008.
(60) Provisional application No. 61/138,734, filed on Dec. 18, 2008.

(51) Int. Cl. C09K 8/60; C07F 7/18; C08G 77/26

(52) U.S. Cl. 507/205; 556/419; 556/420; 528/41

(57) ABSTRACT

Fluorinated compounds represented by formula Rf-Q-X—[Si(R)_{f}(R¹)_{3-f}]_{g}. Each Rf is independently a partially fluorinated or fully fluorinated group selected from Rf^{a}-(O)ᵣ-CHF—(CF₂)ₙ-; [Rf^{b}-(O)ₜ-C(L)H—CF₂—O]ₘ-W—; CF₃CFH—O—(CF₂)ₚ-; CF₃—(O—CF₂)_{z}-; and CF₃—O—(CF₂)₃—O—CF₂—. Methods of treating a surface or a hydrocarbon-bearing formation using the fluorinated compounds and treated articles and treated hydrocarbon-bearing formations are also disclosed.

### CROSS-REFERENCE TO RELATED APPLICATIONS

This application claims priority to U.S. Provisional Application Ser. No. 61/081936, filed Jul. 18, 2008, and to U.S. Provisional Application Ser. No. 61/138734, filed Dec. 18, 2008, the disclosures of which are herein incorporated by reference.

### BACKGROUND

Fluorochemicals have been used in a variety of applications for many years. For example, fluorochemicals have been used to provide properties such as hydrophobicity, oleophobicity, and stain resistance to various materials (e.g., ceramics, metals, fabrics, plastics, and porous stones). The particular properties provided depend, for example, on the particular composition of the fluorochemical and the particular material treated with the fluorochemical.

Traditionally, many widely used fluorinated repellents include long-chain perfluoroalkyl groups, (e.g., perfluorooctyl groups). Recently, however, there has been an industry trend away from using perfluorooctyl fluorochemicals, which has resulted in a desire for new types of surface treatments that provide hydrophobicity, olephobicity, and stain resistance and may be used in a variety of applications.

### SUMMARY

The present disclosure provides compounds that have partially fluorinated polyether groups and/or have fully fluorinated polyether groups with a low number (e.g., up to 4) continuous perfluorinated carbon atoms. The compounds may be useful, for example, as water- and oil-repellent surface treatments. In some embodiments, the compounds disclosed herein unexpectedly raise the contact angle versus water and/or hexadecane to an extent comparable to treatment compositions having a greater number of perfluorinated carbon atoms. The water- and oil-repellent properties of surfaces treated with a fluorinated compound according to the present disclosure render the surfaces more readily cleanable. In some embodiments, these desirable properties are maintained despite extended exposure or use and repeated cleanings (i.e., the fluorinated compounds disclosed herein provide a durable surface treatment).

In one aspect, the present disclosure provides a fluorinated compound represented by formula:

Rf-Q-X—[Si(R)_{f}(R¹)_{3-f}]_{g};

wherein
Rf is selected from the group consisting of:
   Rf^{a}-(O)ᵣ-CHF—(CF₂)ₙ-;
   [Rf^{b}-(O)ₜ-C(L)H—CF₂—O]ₘ-W—;
   CF₃CFH—O—(CF₂)ₚ-;
   CF₃—(O—CF₂)_{z}-; and
   CF₃—O—(CF₂)₃—O—CF₂—;
Q is selected from the group consisting of a bond, —C(O)—N(R²)—, and —C(O)—O—, wherein R² is selected from the group consisting of hydrogen and alkyl having from 1 to 4 carbon atoms;
X is selected from the group consisting of alkylene and arylalkylene, wherein alkylene and arylalkylene are each optionally interrupted by at least one functional group independently selected from the group consisting of ether, amine, ester, amide, carbamate, and urea and optionally substituted by hydroxyl;
Rf^{a} and Rf^{b} independently represent a partially or fully fluorinated alkyl group having from 1 to 10 carbon atoms and optionally interrupted with at least one oxygen atom;
L is selected from the group consisting of F and CF₃;
W is selected from the group consisting of alkylene and arylene;
R is selected from the group consisting of alkyl, aryl, arylalkylenyl, and alkylarylenyl;
R¹ is selected from the group consisting of halide, hydroxyl, alkoxy, aryloxy, acyloxy, and polyalkyleneoxy, wherein alkoxy and acyloxy are optionally substituted by halogen, and wherein aryloxy is optionally substituted by halogen, alkyl, or haloalkyl;
f is 0 or 1;
g is a value from 1 to 2;
r is 0 or 1, wherein when r is 0, then Rf^{a} is interrupted with at least one oxygen atom;
t is 0 or 1;
m is 1, 2, or 3;
n is 0 or 1;
each p is independently a number from 1 to 6; and
z is a number from 2 to 7.
   In some embodiments, g is 1.

In another aspect, the present disclosure provides a composition comprising a fluorinated compound disclosed herein and solvent. In another aspect, the present disclosure provides a composition comprising a fluorinated compound disclosed herein and a compound represented by formula:

(R)_{q}M(R¹)_{r′-q}

wherein
R is selected from the group consisting of alkyl, aryl, arylalkylenyl, and alkylarylenyl;
M is selected from the group consisting of Si, Ti, Zr, and Al,
R¹ is selected from the group consisting of halide, hydroxyl, alkoxy, aryloxy, acyloxy, and polyalkyleneoxy;
r′ is 3 or 4; and
q is 0, 1, or 2.

In another aspect, the present disclosure provides a method comprising treating a surface with a composition comprising a fluorinated compound disclosed herein. In some embodiments, the surface comprises at least one of a ceramic (i.e., glasses, crystalline ceramics, glass ceramics, and combinations thereof), stone such as natural stone (e.g., sandstone, limestone, marble, and granite) or manmade or engineered stone, concrete, or metal. In some embodiments, the surface is a siliceous surface.

In another aspect, the present disclosure provides a method comprising contacting a hydrocarbon-bearing formation with a composition comprising a fluorinated compound disclosed herein. In some embodiments, the hydrocarbon-bearing formation is penetrated by a wellbore, and a region near the wellbore is contacted with the composition. The methods of treating a hydrocarbon-bearing formation disclosed herein are typically useful for increasing the permeability in hydrocarbon-bearing formations having at least one of brine (e.g., connate brine and/or water blocking) or two phases of hydrocarbons (i.e., gas and liquid) in the near wellbore region (e.g., within 25, 20, 15, or 10 feet). Treatment of an oil and/or gas well that has brine and/or two phases of hydrocarbons in the near wellbore region using the methods disclosed herein may increase the productivity of the well. Although not wishing to be bound by theory, it is believed that the fluoropolyether silanes disclosed herein generally at least one of adsorb to, chemisorb onto, or react with hydrocarbon-bearing formations under downhole conditions and modify the wetting properties of the rock in the formation to facilitate the removal of hydrocarbons and/or brine. Methods according to the present disclosure are useful for changing the wettability of a variety of materials found in hydrocarbon-bearing formations, including sand, sandstone, and calcium carbonate. Thus, the treatment methods are more versatile than other treatment methods which are effective with only certain substrates (e.g., sandstone). Methods disclosed herein can be carried out with one treatment step (i.e., application of one treatment composition).

In another aspect, the present disclosure provides an article comprising a surface, wherein at least a portion of the surface is treated with a siloxane, the siloxane comprising at least one condensation product of a fluorinated compound disclosed herein. In some embodiments, the siloxane is covalently bonded to the surface. In some embodiments, the surface comprises at least one of a ceramic (i.e., glasses, crystalline ceramics, glass ceramics, and combinations thereof), stone such as natural stone (e.g., sandstone, limestone, marble, and granite) or manmade or engineered stone, concrete, or metal. In some embodiments, the surface is a siliceous surface.

In this application:

The terms “a”, “an”, and “the” are used interchangeably with the term “at least one”.

The phrase “at least one of” followed by a list refers to any one of the items in the list and any combination of two or more items in the list.

“Alkyl group” and the prefix “alk-” are inclusive of both straight chain and branched chain groups and of cyclic groups. In some embodiments, alkyl groups have up to 30 carbons (in some embodiments, up to 20, 15, 12, 10, 8, 7, 6, or 5 carbons) unless otherwise specified. Cyclic groups can be monocyclic or polycyclic and, in some embodiments, have from 3 to 10 ring carbon atoms.

“Alkylene” is the multivalent (e.g., divalent or trivalent) form of the “alkyl” groups defined above.

“Arylalkylene” refers to an “alkylene” moiety to which an aryl group is attached.

The term “aryl” as used herein includes carbocyclic aromatic rings or ring systems, for example, having 1, 2, or 3 rings and optionally containing at least one heteroatom (e.g., O, S, or N) in the ring. Examples of aryl groups include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

The term “hydrocarbon-bearing formation” includes both hydrocarbon-bearing formations in the field (i.e., subterranean hydrocarbon-bearing formations) and portions of such hydrocarbon-bearing formations (e.g., core samples).

The term “contacting” includes placing a composition within a hydrocarbon-bearing formation using any suitable manner known in the art (e.g., pumping, injecting, pouring, releasing, displacing, spotting, or circulating the fluorinated polymer into a well, wellbore, or hydrocarbon-bearing formation).

In this application, all numerical ranges are inclusive of their endpoints and non-integral values between the endpoints unless otherwise stated.

### BRIEF DESCRIPTION OF THE DRAWINGS

For a more complete understanding of the features and advantages of the present disclosure, reference is now made to the detailed description along with the accompanying figures and in which:

FIG. 1 is a schematic illustration of an exemplary embodiment of an offshore oil platform operating an apparatus for progressively treating a near wellbore region according to some embodiments of the present disclosure;

FIG. 2 is a schematic illustration of the flow apparatus used for Examples 37 to 41 and Control Examples A to C; and

FIG. 3 is a schematic illustration of a core flood set-up that can be used to evaluate the method disclosed herein in a laboratory.

### DETAILED DESCRIPTION

For fluorinated compounds represented by formula Rf-Q-X—[Si(R)_{f}(R¹)_{3-f}]_{g} and siloxanes comprising at least one condensation product thereof, Rf is selected from the group consisting of:

Rf^{a}-(O)ᵣ-CHF—(CF₂)ₙ- I;

[Rf^{b}-(O)ₜ-C(L)H—CF₂—O]ₘ-W— II;

CF₃CFH—O—(CF₂)ₚ- III;

CF₃—(O—CF₂)_{z}- IV;

and

CF₃O—(CF₂)₃—O—CF₂— V.

In some embodiments of Formula Rf-Q-X—[Si(R)_{f}(R¹)_{3-f}]_{g} and siloxanes comprising at least one condensation product thereof, Rf is selected from the group consisting of Rf^{a}-(O)ᵣ-CHF—(CF₂)ₙ-, [Rf^{b}-(O)ₜ-C(L)H—CF₂—O]ₘ-W—, and CF₃CFH—O—(CF₂)ₚ-. In other embodiments, Rf is selected from the group consisting of CF₃—(O—CF₂)_{z}- and CF₃—O—(CF₂)₃—O—CF₂—.

In some embodiments of Formula Rf-Q-X—[Si(R)_{f}(R¹)_{3-f}]_{g} and siloxanes comprising at least one condensation product thereof, Rf has a molecular weight of up to 600 grams per mole (in some embodiments, up to 500, 400, or even up to 300 grams per mole).

In Formulas I and II, Rf^{a} and Rf^{b} independently represent a partially or fully fluorinated alkyl group having from 1 to 10 carbon atoms and optionally interrupted with at least one oxygen atom. Rf^{a} and Rf^{b} include linear and branched alkyl groups. In some embodiments, Rf^{a} and/or Rf^{b} is linear. In some embodiments, Rf^{a} and Rf^{b} independently represent a fully fluorinated alkyl group having up to 6 (in some embodiments, 5, 4, 3, 2, or 1) carbon atoms. In some embodiments, Rf^{a} and Rf^{b} independently represent a fully fluorinated alkyl group interrupted with at least one oxygen atom, of which the alkyl groups between oxygen atoms have up to 6 (in some embodiments, 5, 4, 3, 2, or 1) carbon atoms, and wherein the terminal alkyl group has up to 6 (in some embodiments, 5, 4, 3, 2, or 1) carbon atoms. In some embodiments, Rf^{a} and Rf^{b} independently represent a partially fluorinated alkyl group having up to 6 (in some embodiments, 5, 4, 3, 2, or 1) carbon atoms and up to 2 hydrogen atoms. In some embodiments, Rf^{a} and Rf^{b} independently represent a partially fluorinated alkyl group having up 2 hydrogen atoms interrupted with at least one oxygen atom, of which the alkyl groups between oxygen atoms have up to 6 (in some embodiments, 5, 4, 3, 2, or 1) carbon atoms, and wherein the terminal alkyl group has up to 6 (in some embodiments, 5, 4, 3, 2, or 1) carbon atoms.

In some embodiments of Formulas I and II, Rf^{a} and Rf^{b} are independently represented by formula

R_{f}¹—[OR_{f}²]ₓ-[OR_{f}³]_{y}-.

R_{f}¹ is a perfluorinated alkyl group having from 1 to 6 (in some embodiments, 1 to 4) carbon atoms. R_{f}² and R_{f}³ are each independently perfluorinated alkylene having from 1 to 4 carbon atoms. x and y are each independently a number from 0 to 4, and the sum of x and y is at least 1. In some of these embodiments, t is 1, and r is 1.

In some embodiments of Formulas I and II, Rf^{a} and Rf^{b} are independently represented by formula

R_{f}⁴—[OR_{f}⁵]ₐ-[OR_{f}⁶]_{b}-O—CF₂—.

R_{f}⁴ is a perfluorinated alkyl group having from 1 to 6 (in some embodiments, 1 to 4) carbon atoms. R_{f}⁵ and R_{f}⁶ are each independently perfluorinated alkylene having from 1 to 4 carbon atoms. a and b are each independently numbers from 0 to 4. In some of these embodiments, t is 0, and r is 0.

In some embodiments of Formulas I and II, Rf^{a} and Rf^{b} are independently represented by formula R_{f}⁷—(OCF₂)ₚ-, wherein p is a number from 1 to 6 (in some embodiments, 1 to 4), and R_{f}⁷ is selected from the group consisting of a partially fluorinated alkyl group having 1, 2, 3, 4, 5, or 6 carbon atoms and 1 or 2 hydrogen atoms and a fully fluorinated alkyl group having 1, 2, 3 or 4 carbon atoms.

In some embodiments of Formulas I and II, Rf^{a} and Rf^{b} are independently represented by formula R_{f}⁸—O—(CF₂)ₚ-, wherein p is a number from 1 to 6 (in some embodiments, 1 to 4) and R_{f}⁸ is selected from the group consisting of a partially fluorinated alkyl group having 1, 2, 3, 4, 5, or 6 carbon atoms and 1 or 2 hydrogen atoms and a fully fluorinated alkyl group having 1, 2, 3 or 4 carbon atoms.

In Formula II, L is selected from the group consisting of F and CF₃. In some embodiments of Formula II, L is F. In other embodiments, L is CF₃.

In Formula II, W is selected from the group consisting of alkylene and arylene. Alkylene includes linear, branched, and cyclic alkylene groups having from 1 to 10 (in some embodiments, 1 to 4) carbon atoms. In some embodiments, W is methylene. In some embodiments, W is ethylene. Arylene includes groups having 1 or 2 aromatic rings, optionally having at least one heteroatom (e.g., N, O, and S) in the ring, and optionally substituted with at least one alkyl group or halogen atom. In some embodiments, W is phenylene.

In Formulas II, t is 0 or 1. In some embodiments, t is 1. In some embodiments, t is 0. In embodiments wherein t is 0, Rf^{b} is typically interrupted by at least one oxygen atom.

In Formula II, m is 1, 2, or 3. In some embodiments, m is 1.

In Formula I, n is 0 or 1. In some embodiments, n is 0. In some embodiments, n is 1.

In Formulas III, p is a number from 1 to 6 (e.g., 1, 2, 3, 4, 5, or 6). In some embodiments, p is 1, 2, 5, or 6. In some embodiments, p is 3. In some embodiments, p is 1 or 2. In some embodiments, p is 5 or 6.

In Formula IV, z is a number from 2 to 7 (e.g., 2, 3, 4, 5, 6, or 7). In some embodiments, z is a number from 2 to 6, 2 to 5, 2 to 4, 3 to 5, or 3 to 4.

In some embodiments, fluorinated compounds according to the present disclosure have an Rf group represented by Formula III (i.e., CF₃CFH—O—(CF₂)ₚ-). In some of these embodiments Rf is selected from the group consisting of CF₃CFH—O—(CF₂)₃— and CF₃CFH—O—(CF₂)₅—.

In some embodiments, fluorinated compounds according to the present disclosure have an Rf group represented by Formula I. In some of these embodiments, Rf is selected from the group consisting of:

C₃F₇—O—CHF—;

CF₃—O—CF₂CF₂—CF₂—O—CHF—;

CF₃CF₂CF₂—O—CF₂CF₂—CF₂—O—CHF—;

CF₃—O—CF₂—CF₂—O—CHF—;

CF₃—O—CF₂—O—CF₂—CF₂—O—CHF—;

CF₃—(O—CF₂)₂—O—CF₂—CF₂—O—CHF—;

and

CF₃—(O—CF₂)₃—O—CF₂—CF₂—O—CHF—.

In other of these embodiments, Rf is selected from the group consisting of:

CF₃—O—CHF—CF₂—;

CF₃—O—CF₂—CF₂—O—CHF—CF₂—;

CF₃—CF₂—O—CHF—CF₂—;

CF₃—O—CF₂—CF₂—CF₂—O—CHF—CF₂—;

CF₃—O—CF₂—O—CF₂—CF₂—O—CHF—CF₂—;

CF₃—(O—CF₂)₂—O—CF₂—CF₂—O—CHF—CF₂—;

and

CF₃—(O—CF₂)₃—O—CF₂—CF₂—O—CHF—CF₂—.

In other of these embodiments, Rf is selected from the group consisting of:

CF₃—O—CF₂—CHF—;

C₃F₇—O—CF₂—CHF—;

CF₃—O—CF₂—CF₂—CF₂—O—CF₂—CHF—;

CF₃—O—CF₂—O—CF₂—CF₂—O—CF₂—CHF—;

CF₃—(O—CF₂)₂—O—CF₂—CF₂—O—CF₂—CHF—;

and

CF₃—(O—CF₂)₃—O—CF₂—CF₂—O—CF₂—CHF—.

In other of these embodiments, Rf is selected from the group consisting of:

CF₃—O—CF₂—CHF—CF₂—;

C₂F₅—O—CF₂—CHF—CF₂—;

C₃F₇—O—CF₂—CHF—CF₂—;

CF₃—O—CF₂—CF₂—CF₂—O—CF₂—CHF—CF₂—;

CF₃—O—CF₂—O—CF₂—CF₂—O—CF₂—CHF—CF₂—;

CF₃—(O—CF₂)₂—O—CF₂—CF₂—O—CF₂—CHF—CF₂—;

and

CF₃—(O—CF₂)₃—O—CF₂—CF₂—O—CF₂—CHF—CF₂—.

In other of these embodiments, Rf is selected from the group consisting of:

CF₃—O—CF₂CF₂—CF₂—O—CHF—;

CF₃—O—CF₂—CF₂—CF₂—O—CHF—CF₂—;

CF₃—O—CF₂—CF₂—CF₂—O—CF₂—CHF—;

and

CF₃—O—CF₂—CF₂—CF₂—O—CF₂—CHF—CF₂—.

In some embodiments, fluorinated compounds according to the present disclosure have an Rf group represented by Formula II. In some of these embodiments, L is F, m is 1, and W is alkylene. In some of these embodiments, Rf is selected from the group consisting of:

CF₃—O—CHF—CF₂—O—CH₂—;

CF₃—O—CF₂—CF₂—CF₂—O—CHF—CF₂—O—CH₂;

C₃F₇—O—CHF—CF₂—O—CH₂—;

C₃F₇—O—CHF—CF₂—O—CH₂—CH₂—;

C₃F₇—O—CF₂—CF₂—O—CHF—CF₂—OCH₂—;

and

C₃F₇—O—CF₂—CF₂—CF₂—O—CHF—CF₂—OCH₂—.

In other of these embodiments, Rf is represented by formula C₃F₇—O—CF₂—CHF—CF₂—OCH₂—. In other of these embodiments, Rf is selected from the group consisting of:

CF₃—CHF—CF₂—O—CH₂—;

and

C₃F₇—CF₂—CHF—CF₂—OCH₂—.

In some embodiments, fluorinated compounds according to the present disclosure have an Rf group represented by Formula IV (i.e., CF₃—(O—CF₂)_{z}-). In some of these embodiments, z is a number from 2 to 6, 2 to 5, 2 to 4, 3 to 5, or 3 to 4.

In some embodiments, fluorinated compounds according to the present disclosure have an Rf represented by Formula V (i.e., CF₃—O—(CF₂)₃—O—CF₂—).

In Formula Rf-Q-X—[Si(R)_{f}(R¹)_{3-f}]_{g} and siloxanes comprising at least one condensation product thereof, Q is selected from the group consisting of a bond, —C(O)—N(R²)—, and —C(O)—O—, wherein R² is hydrogen or alkyl having 1 to 4 carbon atoms (e.g., methyl, ethyl, n-propyl, isopropyl, n-butyl, isobutyl, or sec-butyl). In some embodiments, Q is selected from the group consisting of —C(O)—N(R²)— and —C(O)—O—. In some embodiments, Q is selected from the group consisting of a bond and —C(O)—N(R²)—. In some embodiments, Q is —C(O)—N(R²)—. In some embodiments, R² is hydrogen or methyl. In some embodiments, R² is hydrogen. It should be understood that when Q is a bond, compounds represented by Formula Rf-Q-X—[Si(R)_{f}(R¹)_{3-f}]_{g} can also be represented by Formula Rf—X—[Si(R)_{f}(R¹)_{3-f}]_{g}.

In Formula Rf-Q-X—[Si(R)_{f}(R¹)_{3-f}]_{g} and siloxanes comprising at least one condensation product thereof, X is selected from the group consisting of alkylene and arylalkylene, wherein alkylene and arylalkylene are each optionally interrupted by at least one functional group independently selected from the group consisting of ether (i.e., —O—), amine (i.e., —N(R²)—), ester, (i.e., —O—C(O)— or —C(O)—O—), amide (i.e., —N(R²)—C(O)— or —C(O)—N(R²)—), carbamate (i.e., —N(R²)—C(O)—O— or —O—C(O)—N(R²)—), and urea (i.e., —N(R²)—C(O)—N(R²)—), wherein in any of these functional groups, R² is as defined in any of the above embodiments. The phrase “interrupted by at least one functional group” refers to having alkylene or arylalkylene on either side of the functional group. Alkylene and arylalkylene are also each optionally substituted by hydroxyl. In some embodiments, X is alkylene having up to 5 carbon atoms. In some embodiments, X is alkylene having up to 10 (in some embodiments, up to 12, 15, 18, 20, 22, 25, 28, or 30) carbon atoms. In some embodiments, X is alkylene that is optionally interrupted by at least one ether group. In some of these embodiments, alkylene is interrupted by one ether group. In some of these embodiments, X is -[EO]ₕ-[R′O]ᵢ-[EO]ₕ- or —[R′O]ᵢ-[EO0]ₕ-[R′O]ᵢ-, wherein EO represents —CH₂CH₂O—; each R′O independently represents —CH(CH₃)CH₂O—, —CH₂CH(CH₃)O—, —CH(CH₂CH₃)CH₂O—, —CH₂CH(CH₂CH₃)O—, or —CH₂C(CH₃)₂O— (in some embodiments, —CH(CH₃)CH₂O— or —CH₂CH(CH₃)O—); each h is independently a number from 1 to 150 (in some embodiments, from 7 to about 150, 14 to about 125, 5 to 15, or 9 to 13); and each i is independently a number from 0 to 55 (in some embodiments, from about 21 to about 54, 15 to 25, 9 to about 25, or 19 to 23). In some embodiments, X is alkylene that is interrupted by at least one functional group independently selected from the group consisting of ether (i.e., —O—) and carbamate (i.e., —N(R²)—C(O)—O— or —O—C(O)—N(R²)—).

In some embodiments of the fluorinated compounds disclosed herein, f is 1. In other embodiments, f is 0.

In some embodiments of the fluorinated compounds disclosed herein, g is 1. In other embodiments, g is 2.

In Formulas Rf-Q-X—-[Si(R)_{f}(R¹)_{3-f}]_{g} and (R)_{q}M(R¹)_{r′-q}, each R is independently selected from the group consisting of alkyl, aryl, arylalkylenyl, and alkylarylenyl. In some embodiments, each R is independently alkyl having from 1 to 6 carbon atoms (e.g., methyl, ethyl, n-propyl, isopropyl, n-butyl, isobutyl, sec-butyl, n-pentyl, isopentyl, neopentyl, or n-hexyl). In some embodiments, each R is independently methyl or ethyl.

In Formulas Rf-Q-X—[Si(R)_{f}(R¹)_{3-f}]_{g} and (R)_{q}M(R¹)_{r′-q}, each R¹ is independently selected from the group consisting of is selected from the group consisting of halide (i.e., fluoride, chloride, bromide, or iodine), hydroxyl (i.e., —OH), alkoxy (e.g., —O—alkyl), aryloxy (e.g., —O-aryl), acyloxy (e.g., —O—C(O)-alkyl), and polyalkyleneoxy (e.g., -[EO]ₕ-[R′O]ᵢ-[EO]ₕ-R″ or —[R′O]ᵢ-[EO]ₕ-[R′O]ᵢ-R″, wherein EO, R′O, i, and h are as defined above, and wherein R″ is hydrogen or alkyl having up to four carbon atoms. In some embodiments, alkoxy and acyloxy have up to 6 (or up to 4) carbon atoms, and the alkyl group is optionally substituted by halogen. In some embodiments, aryloxy has 6 to 12 (or 6 to 10) carbon atoms which may be unsubstituted or substituted by halogen, alkyl (e.g., having up to 4 carbon atoms), and haloalkyl. In some embodiments, each R¹ is independently selected from the group consisting of halide, hydroxyl, alkoxy, aryloxy, and acyloxy. In some embodiments, each R¹ is independently selected from the group consisting of halide (e.g., chloride) and alkoxy having up to ten carbon atoms. In some embodiments, each R¹ is independently alkoxy having from 1 to 6 (e.g., 1 to 4) carbon atoms. In some embodiments, each R¹ is independently methoxy or ethoxy. The R¹ groups are generally capable of hydrolyzing under, for example, acidic or basic aqueous conditions to provide groups (e.g., silanol groups) capable of undergoing condensation reactions.

In some embodiments of fluorinated compounds according to the present disclosure, Q is —C(O)—N(R²)—, and X is alkylene having up to 8 (e.g., 1, 2, 3, 4, 5, 6, 7, or 8) carbon atoms, wherein X is optionally interrupted by at least one functional group independently selected from the group consisting of ether and carbamate.

In Formula (R)_{q}M(R¹)_{r′-q}, M is selected from the group consisting of Si, Ti, Zr, and Al. In some embodiments, M is selected from the group consisting of Si, Ti, and Zr. In some embodiments, M is Si. In some embodiments, r′ is 4 (e.g., when M is Si, Ti, and Zr). When M is Al, r′ is 3. In some embodiments, q is 0 or 1. In some embodiments, (R)_{q}M(R¹)_{r′-q} is Si(O-alkyl)₄.

Compounds represented by Formula Rf-Q-X—[Si(R)_{f}(R¹)_{3-f}]_{g} can be prepared, for example, starting with a partially or fully fluorinated carboxylic acid, a salt thereof, a carboxylic acid ester, or a carboxylic acid halide. Partially and fully fluorinated carboxylic acids and salts thereof, carboxylic acid esters, and carboxylic acid halides can be prepared by known methods. For example, starting materials represented by formula Rf^{a}-(O)ᵣ-CHF—(CF₂)ₙ-C(O)G or [Rf^{b}-(O)ₜ-C(L)H—CF₂—O]ₘ-W—C(O)G, wherein G represents —OH, —O-alkyl (e.g., having from 1 to 4 carbon atoms), or —F and Rf^{a}, Rf^{b}, n, m, L, t, r, and W are as defined above, can be prepared from fluorinated olefins of Formula VI or VII:

Rf^{b}-(O)ₜ-CF═CF₂ VI,

or

Rf^{a}-(O)ᵣ-CF═CF₂ VII,

wherein Rf^{a}, Rf^{b}, and t are as defined above. Numerous compounds of Formula VI or VII are known (e.g., perfluorinated vinyl ethers and perfluorinated allyl ethers), and many can be obtained from commercial sources (e.g., 3M Company, St. Paul, Minn., and E.I. du Pont de Nemours and Company, Wilmington, Del.). Others can be prepared by known methods; (see, e.g., U.S. Pat. No. 5,350,497 (Hung et al.) and U.S. Pat. No. 6,255,536 (Worm et al.)).

Compounds of formula Rf^{a}-(O)ᵣ-CHF—(CF₂)ₙ-C(O)G, wherein n is 0, can be prepared, for example, by reacting a fluorinated olefin of Formula VII with a base (e.g., ammonia, alkali metal hydroxides, and alkaline earth metal hydroxides). Alternatively, for example, a fluorinated olefin of Formula VII can be reacted with an aliphatic alcohol (e.g., methanol, ethanol, n-butanol, and t-butanol) in an alkaline medium, and the resulting ether can be decomposed under acidic conditions to provide a fluorinated carboxylic acid of formula Rf^{a}-(O)ᵣ-CHF—(CF₂)ₙ-C(O)G, wherein n is 0. Compounds of formula Rf^{a}-(O)ᵣ-CHF—(CF₂)ₙ-C(O)G, wherein n is 1, can be prepared, for example, by a free radical reaction of the fluorinated olefin of Formula VII with methanol followed by an oxidation of the resulting reaction product using conventional methods. Conditions for these reactions are described, for example, in U.S. Pat. App. No. 2007/0015864 (Hintzer et al.), relating to the preparation of compounds of formula Rf^{a}-(O)ᵣ-CHF—(CF₂)ₙ-C(O)G. These methods may be useful, for example, for providing structurally pure compounds (e.g., free of other compounds containing other fluorinated segments). In some embodiments, compounds according to the present disclosure are at least 95% (e.g., 96, 97, 98, or 99%) pure.

Fluorinated vinyl ethers of Formulas VI or VII, wherein r and/or t is 1, can be oxidized (e.g., with oxygen) in the presence of a fluoride source (e.g., antimony pentafluoride) to carboxylic acid fluorides of formula Rf^{a}-O—CF₂C(O)F according to the methods described in U.S. Pat. No. 4,987,254 (Schwertfeger et al.), in column 1, line 45 to column 2, line 42. Examples of compounds that can be prepared according to this method include CF₃—(CF₂)₂—O—CF₂—C(O)—CH₃ and CF₃—O—(CF₂)₃—O—CF₂—C(O)—CH₃, which are described in U.S. Pat. No. 2007/0015864 (Hintzer et al.), relating to the preparation of these compounds. These methods may be useful, for example, for providing structurally pure compounds (e.g., free of other compounds containing other fluorinated segments). In some embodiments, compounds according to the present disclosure are at least 95% (e.g., 96, 97, 98, or 99%) pure.

Compounds of formula [Rf^{b}-(O)ₜ-C(L)H—CF₂—O]ₘ-W—C(O)G can be prepared, for example, by reaction of a fluorinated olefin of Formula VI with a hydroxyl compound of Formula VIII according to the reaction:

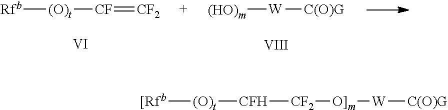

wherein Rf^{b} and t are as defined above, m is 1, 2, or 3, W is alkylene or arylene, and G is as defined above. Typically, G represents —O-alkyl (e.g., having from 1 to 4 carbon atoms in the alkyl group). Compounds of Formula VIII can be obtained, for example, from commercial sources or can be prepared by known methods. The reaction can be carried out, for example, under conditions described in U.S. Pat. App. No. 2007/0015864 (Hintzer et al.), relating to the preparation of compounds of formula [Rf^{b}-(O)ₜ-C(L)H—CF₂—O]ₘ-W—C(O)G.

Fluorinated carboxylic acids and their derivatives according to formula CF₃CFH—O—(CF₂)ₚ-C(O)G can be prepared, for example, by decarbonylation of difunctional perfluorinated acid fluoride according to the reaction:

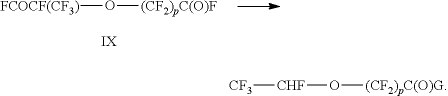

The reaction is typically carried out at an elevated temperature in the presence of water and base (e.g., a metal hydroxide or metal carbonate) according to known methods; see, e.g., U.S. Pat. No. 3,555,100 (Garth et al.), relating to the decarbonylation of difunctional acid fluorides.

Compounds of Formula IX are available, for example, from the coupling of perfluorinated diacid fluorides of Formula X and hexafluoropropylene oxide according to the reaction:

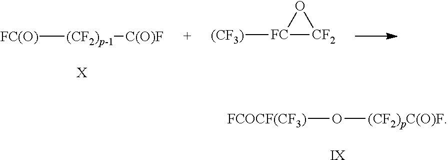

Compounds of Formula X are available, for example, by electrochemical fluorination or direct fluorination of a difunctional ester of formula CH₃OCO(CH₂)ₚ₋₁COOCH₃ or a lactone of formula:

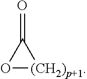

General procedures for carrying out electrochemical fluorination are described, for example, in U.S. Pat. No. 2,713,593 (Brice et al.) and International App. Pub. No. WO 98/50603, published Nov. 12, 1998. General procedures for carrying out direct fluorination are described, for example, in U.S. Pat. No. 5,488,142 (Fall et al.).

Some carboxylic acids and carboxylic acid fluorides useful for preparing compounds represented by formula Rf-Q-X—[Si(R)_{f}(R¹)_{3-f}]_{g} are commercially available. For example, carboxylic acids of formula CF₃[O—CF₂]₁₋₃C(O)OH are available from Anles Ltd., St. Petersburg, Russia.

Compounds represented by Formula Rf-Q-X—[Si(R)_{f}(R¹)_{3-f}]_{g} can be prepared, for example, from a partially or fully fluorinated carboxylic acid or salt thereof, an acid fluoride thereof, or a carboxylic acid ester (e.g., Rf—C(O)—OCH₃) using a variety of conventional methods. For example, a methyl ester can be treated with an amine having formula NH₂—X—[Si(R)_{f}(R¹)_{3-f]}_{g} according to the following reaction sequence.

Rf—C(O)—OCH₃+NH₂—X—[Si(R)_{f}(R¹)_{3-f}]_{g}→Rf—C(O)—NH—X—[Si(R)_{f}(R¹)_{3-f}]_{g} In this sequence, Rf, X, R, R¹, f, and g are as defined in any of the above embodiments. Some amines having formula NH₂—X—Si(R)_{f}(R¹)_{3-f} are commercially available (e.g., (3-aminopropyl)trimethoxysilane and (3-aminopropyl)triethoxysilane). The reaction may be carried out, for example, at an elevated temperature (e.g., up to 80° C., 70° C., 60° C., or 50° C.), and may be carried out neat or in a suitable solvent.

Compounds represented by Formula Rf-Q-X—[Si(R)_{f}(R¹)_{3-f}]_{g} can also be prepared, for example, by reaction of a carboxylic acid ester (e.g., Rf—C(O)—OCH₃) with an amino alcohol having formula NH₂—X″—[OH]_{g} (e.g., ethanolamine or 3-amino-1,2-propanediol) to prepare alcohol-substituted Rf—(CO)NHX″[OH]_{g} as shown in the following reaction sequence, wherein Rf is as defined in any of the above embodiments, and X″ is a precursor to X, wherein X is interrupted by at least one ether, ester, or carbamate group.

Rf—C(O)—OCH₃+NH₂—X″—[OH]_{g}→Rf—C(O)—NH—X″—[OH]_{g}→Rf—C(O)—NH—X—[Si(R)_{f}(R¹)_{3-f}]_{g}

The conditions for the reaction with NH₂—X—Si(R)_{f}(R¹)_{3-f}, described above, can be used for the reaction with NH₂—X″—OH. The hydroxyl-substituted compound can then be treated with, for example, a haloalkyl silane (e.g., chloropropyltrimethoxysilane), an isocyantoalkyl silane (e.g., 3-isocyanatopropyltriethoxysilane), or an epoxy silane (e.g., gamma-glycidoxypropyltrimethoxysilane). The reaction with a haloalkyl silane can be carried out, for example, by first treating the hydroxyl-substituted compound with a base (e.g., sodium methoxide or sodium tert-butoxide) in a suitable solvent (e.g., methanol), optionally at an elevated temperature (e.g., up to the reflux temperature of the solvent), followed by heating (e.g., at up to 100° C., 80° C., or 70° C.) the resulting alkoxide with the haloalkyl silane. The reaction of a hydroxyl-substituted compound represented by formula Rf—C(O)—NH—X″—OH with an isocyantoalkyl silane can be carried out, for example, in a suitable solvent (e.g., methyl ethyl ketone), optionally at an elevated temperature (e.g., the reflux temperature of the solvent), and optionally in the presence of a catalyst (e.g., stannous octanoate or tin(II) 2-ethylhexanoate).

Compounds represented by Formula Rf-Q-X—[Si(R)_{f}(R¹)_{3-f}]_{g} can also be prepared, for example, by reducing an ester of formula Rf—C(O)—OCH₃ or a carboxylic acid of formula Rf—C(O)—OH using conventional methods (e.g., hydride, such as sodium borohydride, reduction) to a hydroxyl-substituted compound of formula Rf—CH₂OH as shown in the following reaction sequence, wherein Rf, R, R¹, and f are as defined in any of the above embodiments, and X is interrupted by at least one ether, ester, or carbamate group.

Rf—C(O)—OCH₃→Rf—CH₂OH→Rf—X—Si(R)_{f}(R¹)_{3-f}

The hydroxyl-substituted compound of formula Rf—CH₂OH can then be converted, for example, to a silane by reaction with a haloalkyl silane or isocyanatoalkyl silane using the techniques described above.

Fluorinated hydroxyl compounds can also be treated, for example, with acryloyl halides, esters, anhydrides or acrylic acid to produce fluorinated acrylate esters, which can then be treated, for example, with amines having formula NH(_{(3-g)}-[X″—Si(R)_{f}(R¹)_{3-f}]_{g}, wherein R, R¹, f, and g can be defined as in any of the above embodiments, and X′″ is alkylene, according to the methods described in U.S. Pat. Appl. No. 2008/0220264 (Iyer et al.), relating to the preparation of fluorinated silanes.

Hydrolysis of the R¹ groups (e.g., alkoxy, acyloxy, or halogen) of compounds represented by formula Rf-Q-X—[Si(R)_{f}(R¹)_{3-f}]_{g} typically generates silanol groups, which participate in condensation reactions to form siloxanes and/or participate in bonding interactions with silanol groups or other metal hydroxide groups on the surface of articles (e.g., hydrocarbon-bearing formations, proppants, or others) treated according to the present disclosure. The bonding interaction may be through a covalent bond (e.g., through a condensation reaction), through hydrogen bonding, or other types of bonding (e.g., Van Der Waals interactions). Hydrolysis can occur, for example, in the presence of water optionally in the presence of an acid or base. The water necessary for hydrolysis made be added to a composition containing the fluorinated compound represented by formula Rf-Q-X—[Si(R)_{f}(R¹)_{3-f}]_{g} that is used to treat the article, may be adsorbed to the surface of the article, or may be present in the atmosphere to which the fluorinated compound is exposed (e.g., an atmosphere having a relative humidity of at least 10%, 20%, 30%, 40%, or even at least 50%).

Under neutral pH conditions, the condensation of silanol groups is typically carried out at elevated temperature (e.g., in a range from 40° C. to 200° C. or even 50° C. to 100° C.). Under acidic conditions, the condensation of silanol groups may be carried out at room temperature (e.g., in a range from about 15° C. to about 30° C. or even 20° C. to 25° C.). The rate of the condensation reaction is typically dependent upon temperature, pH, and the concentration of the compound represented by formula Rf-Q-X—[Si(R)_{f}(R¹)_{3-f}]_{g} (e.g., in a formulation containing the fluorinated compound).

In some embodiments of compositions comprising a fluorinated compound disclosed herein, the composition includes water. In some embodiments, the amount of water is between 0.1 and 20 (e.g., 0.5 to 15 or 1 to 10) percent by weight based on the total weight of the composition.

In some embodiments, compositions according to and/or useful in practicing the present disclosure comprise one of an acid or a base. The acid may be an organic or inorganic acid. Organic acids include acetic acid, citric acid, formic acid, and fluorinated organic acids, such as CF₃SO₃H, C₃F₇COOH, C₇F₁₅COOH, C₆F₁₃P(O)(OH)₂, or a fluorinated organic acid represented by the Formula R_{f}⁹—[—(Y)ⱼ-Z]ₖ, wherein R_{f}⁹ represents a mono or divalent polyfluoropolyether group, Y represents an organic divalent linking group, Z represents an acid group (e.g., a carboxylic acid group), j is 0 or 1, and k is 1 or 2. Exemplary fluorinated organic acids represented by formula R_{f}⁹—[—(Y)ⱼ-Z]ₖ include C₃F₇O(CF(CF₃)CF₂O)₁₀₋₃₀CF(CF₃)COOH (commercially available from E. I. DuPont de Nemours and Company, Wilmington, Del., under the trade designations “KRYTOX 157 FSH”, “KRYTOX 157 FSL”, and “KRYTOX 157 FSM”) and CF₃(CF₂)₂OCF(CF₃)COOH. Examples of inorganic acids include sulfuric acid, hydrochloric acid, and phosphoric acid. The acid will generally be included in the composition in an amount between about 0.005 and 10% (e.g., between 0.01 and 10% or between 0.05 and 5%) by weight, based on the total weight of the composition. In some embodiments, the acid is at least one of acetic acid, citric acid, formic acid, para-toluenesulfonic acid, triflic acid, perfluorobutyric acid, hydroboric acid, sulfuric acid, phosphoric acid, or hydrochloric acid.

In some embodiments, compositions according to and/or useful in practicing the present disclosure comprise a base. In some embodiments, the base is at least one of an amine (e.g., triethylamine), an alkali metal hydroxide (e.g., sodium hydroxide or potassium hydroxide), an alkaline earth metal hydroxide, or ammonium hydroxide. The base will generally be included in the composition in an amount between about 0.005 and 10% (e.g., between 0.01 and 10% or between 0.05 and 5%) by weight, based on the total weight of the composition.

In some embodiments, compositions according to and/or useful in practicing the present disclosure include solvent (e.g., one or more organic solvents). The term solvent refers to a liquid material or a mixture of liquid materials that is capable of at least partially dissolving a fluorinated compound disclosed herein at 25° C. The solvent may or may not include water. In some embodiments, the solvent is capable of dissolving at least 0.01% by weight of the fluorinated compound disclosed herein. In some embodiments, the solvent is an organic solvent capable of dissolving at least 0.1% by weight water. In some embodiments, the solvent is capable of dissolving at least 0.01% by weight acid or base.

Suitable organic solvents include aliphatic alcohols (e.g., methanol, ethanol, or isopropyl alcohol), ketones (e.g., acetone or methyl ethyl ketone), esters (e.g., ethyl acetate or methylformate), and ethers (e.g., diisopropyl ether). Fluorinated solvents may be used in combination with the organic solvents. Examples of fluorinated solvents include fluorinated hydrocarbons (e.g, perfluorohexane or perfluorooctane), partially fluorinated hydrocarbons (e.g., pentafluorobutane or CF₃CFHCFHCF₂CF₃), and hydrofluoroethers, (e.g., methyl perfluorobutyl ether or ethyl perfluorobutyl ether).

In some embodiments, compositions according to and/or useful for practicing the present disclosure comprise a compound represented by formula (R)_{q}M(R¹)_{r′-q}, wherein R, M, R¹, r′, and q are as defined above. Representative compounds of this formula include tetramethoxysilane, tetraethoxysilane, methyltriethoxysilane, dimethyldiethoxysilane, octadecyltriethoxysilane, methyltrichlorosilane, tetramethyl orthotitanate, tetraethyl orthotitanate, tetraisopropyl orthotitanate, tetraethylzirconate, tetraisopropylzirconate, and tetrapropylzirconate.

A composition according to the present disclosure may be a concentrate (e.g., a concentrated solution of a compound represented by formula Rf-Q-X—[Si(R)_{f}(R¹)_{3-f}]_{g} in organic solvent). The concentrate may be stable for several weeks (e.g., at least one, two, or three months). The compound represented by formula Rf-Q-X—[Si(R)_{f}(R¹)_{3-f}]_{g} may be present in an amount of at least 10, 20, 25, 30, or at least 40 percent by weight, based on the total weight of the concentrate. Concentrates may be diluted shortly before use, for example, with water, organic solvent, and optionally acid or base. In some embodiments, the concentrate comprises a compound represented by formula (R)_{q}M(R¹)_{r′-q}. In some of these embodiments, the concentrate comprises the compound represented by formula Rf-Q-X—[Si(R)_{f}(R¹)_{3-f}]_{g} and the compound represented by formula (R)_{q}M(R¹)_{r′-q} in the same weight ratio desired in final, diluted concentration.

A composition (e.g., for treating a surface or a hydrocarbon-bearing formation) typically includes from at least 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.5, 1, 1.5, 2, 3, 4, or 5 percent by weight, up to 5, 6, 7, 8, 9, or 10 percent by weight of at least one fluorinated compound according to the present disclosure, based on the total weight of the composition. For example, the amount of a fluorinated compound according to the present disclosure in a composition may be in a range of from 0.01 to 10, 0.1 to 10, 0.1 to 5, 1 to 10, or from 1 to 5 percent by weight, based on the total weight of the composition. Lower and higher amounts of the fluorinated compound in the composition may also be used, and may be desirable for some applications. The ratio of the solvents, water and optionally other components (e.g., acid, base, or a compound represented by formula (R)_{q}M(R¹)_{r′-q}) may be chosen to provide a homogeneous mixture.

Other components that may be added to a composition disclosed herein include silanes having another functional group (e.g., epoxypropyltrimethoxysilane, bis(3-aminopropyltrimethoxysilyl)amine, or aminopropyltrimethoxysilane). These components may be useful, for example, for enhancing the adhesion of the treatment composition to the article by reacting with the surface of the article.

For methods comprising treating a surface according to the present disclosure, a composition comprising the fluorinated compound represented by formula Rf-Q-X—[Si(R)_{f}(R¹)_{3-f}]_{g} is generally applied to the substrate in amounts sufficient to produce a coating which is water- and oil-repellent. This coating can be extremely thin (e.g. 10 to 200 nanometers) or, in some applications, may be thicker.

In some embodiments of methods and articles according to the present disclosure, a hard surface is treated. Useful surfaces include ceramics, glazed ceramics, glass, metal, natural and man-made stone, thermoplastic materials (e.g., poly(meth)acrylate, polycarbonate, polystyrene, styrene copolymers (e.g., styrene acrylonitrile copolymers), polyesters, or polyethylene terephthalate), paints (such as those based on acrylic resins), powder coatings (such as polyurethane or hybrid powder coatings), and wood. In some embodiments, the surface comprises functional groups capable of reacting with the fluorinated compound according to the present disclosure. Such reactivity of the surface may occur naturally (e.g., in a siliceous surface), or a reactive surface may be provided by treatment in a plasma containing oxygen or in a corona atmosphere.

Various articles can be treated with a fluorinated compound according to the present disclosure to provide a water- and oil-repellent coating thereon. Exemplary articles include ceramic tiles, bathtubs, sinks, toilet bowls, glass shower panels, construction glass, various parts of a vehicle (e.g. mirror or windows), ceramic or enamel pottery materials, lenses used in ophthalmic spectacles, sunglasses, optical instruments, illuminators, watch crystals, plastic window glazing, signs, decorative surfaces such as wallpaper and vinyl flooring, composite or laminated substrates (e.g., sheeting available from Formica Corporation, Cincinnati, OH under the trade designation “FORMICA” and flooring available, for example, from Pergo, Raleigh, N.C. under the trade designation “PERGO”), natural and man-made stones, decorative and paving stones (e.g., marble, granite, limestone, and slate), cement and stone sidewalks and driveways, particles that comprise grout or the finished surface of applied grout, wood furniture surface (e.g., desktops and tabletops), cabinet surfaces, wood flooring, decking, and fencing, leather, paper, fiber glass fabric and other fiber-containing fabrics, textiles, carpeting, kitchen and bathroom faucets, taps, handles, spouts, sinks, drains, hand rails, towel holders, curtain rods, dish washer panels, refrigerator panels, stove tops, panels on stoves, ovens, or microwaves, exhaust hoods, grills, and metal wheels or rims.

In some embodiments, the surface of the article to be treated may be cleaned before treatment so that it is substantially free of organic contamination. Cleaning techniques depend on the type of substrate and include a solvent washing step with an organic solvent (e.g., acetone or ethanol).

A wide variety methods can be used to treat a surface with a composition disclosed herein (e.g., brushing, spraying, dipping, rolling, or spreading). An article can typically be treated with a composition at room temperature (typically, about 20° C. to about 25° C.). Alternatively, the mixture can be applied to substrates that are preheated (e.g., at a temperature of 60° C. to 150° C. This may be useful, for example, in industrial production of, for example, ceramic tiles, which can be treated immediately after exiting the baking oven at the end of the production line. Following application, the treated substrate can be dried and cured at ambient or elevated temperature (e.g., at 40° to 300° C.) and for a time sufficient to dry. In some embodiments, repellent and durable surface treatments according to the present disclosure can be obtained upon treating an article and drying at ambient temperature. In some embodiments, methods disclosed herein further comprise a polishing step to remove excess material.

Fluorinated compounds disclosed herein may also be added to photocuring compositions, for example, epoxy resins to provide hardcoats. The epoxy resins may contain silane groups (e.g., beta-(3,4-epoxycyclohexyl)ethyltrimethoxysilane or gamma-glycidoxypropyltrimethoxysilane).

In some embodiments of compositions and methods according to the present disclosure wherein both a compound represented by formula Rf-Q-X—[Si(R)_{f}(R¹)_{3-f}]_{g} and a compound represented by formula (R)_{q}M(R¹)_{r′-q} are included in the composition, the weight ratio of (R)_{q}M(R¹)_{p-q}:Rf-Q-X—[Si(R)_{f}(R¹)_{3-f}]_{g} may be, for example, in a range from 3:1 to 12:1, or in a range from 6:1 to 9:1. Higher weight ratios (e.g., 6:1 to 12:1) may be useful, for example, when treated articles disclosed herein are exposed to UV and humidity. Lower weight ratios (e.g., 1:1 to 6:1) may be useful, for example, for providing a transparent coating.

A treatment composition comprising a compound represented by formula Rf-Q-X—[Si(R)_{f}(R¹)_{3-f}]_{g}, solvent, and optionally acid, base, or a compound represented by formula (R)_{q}M(R¹)_{r′-q} may be used to treat articles according to the methods disclosed herein either shortly after its preparation, or after standing at room temperature for a period of time (e.g., more than 1 hour, 3 to 8 hours, several days, or several weeks), or after heating the composition. Hydrolysis and condensation of the compounds represented by formulas Rf-Q-X—[Si(R)_{f}(R¹)_{3-f}]_{g} and (R)_{q}M(R¹)_{r′-q} may be more likely to occur after compositions are exposed to time and temperature. Compositions disclosed herein may provide useful properties regardless of the extent of hydrolysis and condensation that takes place in the composition before treating a surface.

The compounds disclosed herein, which have partially fluorinated polyether groups and/or have fully fluorinated polyether groups with a low number (e.g., up to 4) continuous perfluorinated carbon atoms, are herein demonstrated to have useful water- and oil-repellent properties and may provide a lower-cost alternative to repellents having a larger number of continuous perfluorinated carbon atoms. Also, in some embodiments, in has been found that mixtures of compounds represented by formulas Rf-Q-X—[Si(R)_{f}(R¹)_{3-f}]_{g} and (R)_{q}M(R¹)_{r′-q} that contain low amounts (e.g., up to 10, 5, 2.5, or 1 percent by weight, based on the total weight of the composition) of the fluorinated compound represented by formula Rf-Q-X—[Si(R)_{f}(R¹)_{3-f}]_{g} provide useful water- and oil-repellent properties.

In some embodiments, methods according to the present disclosure increase the contact angle of a surface to at least one of water or hexadecane. In some embodiments, the methods provide a treated surface having at a contact angle at 20° C. with distilled water of at least 80°, 85°, 90°, 95°, or at least 100°, measured after the treatment has been dried. In some embodiments, the methods provide a treated surface having at a contact angle at 20° C. with n-hexadecane of at least 40°, 45°, 50°, 55°, or at least 60° measured after the treatment has been dried.

In some embodiments, treating the surface with the composition provides a contact angle of at least one of water or hexadecane on the surface that is higher than a contact angle provided by treating an equivalent surface with a comparative composition, wherein the comparative composition is the same as the composition except that the fluorinated compound is replaced by a silane represented by formula:

C₃F₇—O—CF(CF₃)—C(O)—NH—(CH₂)₃—Si(OCH₂CH₃)₃. The term “equivalent surface” refers to a surface that is the same in all respects except for the identity of the surface treatment.

In some embodiments of articles according to the present disclosure, the siloxane treatment disclosed herein increases a contact angle of at least one of water or hexadecane on the surface to a greater extent than a comparative siloxane, wherein the comparative siloxane is the same as the siloxane except that said at least one condensation product of the fluorinated compound is replaced with at least one condensation product of a silane represented by formula C₃F₇—O—CF(CF₃)—C(O)—NH—(CH₂)₃—Si(OCH₂CH₃)₃.

Compounds according to the present disclosure may also be useful, for example, as additives to plastics. When compounds disclosed herein are added to plastics, the triboloic properties of the plastic may be improved. Compounds according to the present disclosure may be added to plastics by (a) combining the compound and at least one thermoplastic polymer (optionally, along with other additives) and then melt processing the resulting combination; (b) combining the compound and at least one thermosetting polymer or the reactive precursors thereof (optionally, along with other additives) and then curing, optionally with the application of heat or actinic radiation; (c) dissolving the compound and a polymer in at least one solvent and then casting or coating (for example, on a substrate such as plastic sheet or film, fabric, wood, ceramic, or stone) the resulting solution and allowing evaporation of the solvent, optionally with the application of heat; and (d) combining the compound and at least one monomer (optionally, along with other additives) and then polymerizing the monomer, optionally in the presence of at least one solvent and optionally with the application of heat or actinic radiation.

To form a polymer melt blend by melt processing, the compound can be, for example, intimately mixed with pelletized or powdered polymer and then melt processed by known methods such as, for example, molding, melt blowing, melt spinning, or melt extrusion. The compound can be mixed directly with the polymer or it can be mixed with the polymer in the form of a “master batch” (concentrate) of the compound in the polymer. If desired, an organic solution of the compound can be mixed with powdered or pelletized polymer, followed by drying (to remove solvent) and then by melt processing. The compound can also be injected into a molten polymer stream to form a blend immediately prior to, for example, extrusion into fibers or films or molding into articles.

After melt processing, an annealing step can be carried out to enhance the development of repellent characteristics. In addition to, or in lieu of, such an annealing step, the melt processed combination (for example, in the form of a film or a fiber) can also be embossed between two heated rolls, one or both of which can be patterned. An annealing step typically is conducted below the melt temperature of the polymer (for example, in the case of polyamide, at about 150-220° C. for a period of about 30 seconds to about 5 minutes.

Compounds according to the present disclosure can be added to thermoplastic or thermosetting polymer (or, alternatively, to other treatable substrate materials) in amounts sufficient to achieve the desired properties for a particular application without compromising the properties of the polymer (or other treatable substrate material). Generally, the compounds disclosed herein can be added in amounts ranging from about 0.1 to about 10 percent by weight (preferably, from about 0.5 to about 4 percent; more preferably, from about 0.75 to about 2.5 percent) based on the weight of polymer (or other treatable substrate material).

Treatment compositions useful for practicing the method of treating a hydrocarbon-bearing formation disclosed herein comprise solvent. Examples of useful solvents for these methods include organic solvents, water, easily gasified fluids (e.g., ammonia, low molecular weight hydrocarbons, and supercritical or liquid carbon dioxide), and combinations thereof. In some embodiments, the compositions are essentially free of water (i.e., contains less than 0.1 percent by weight of water based on the total weight of the composition). In some embodiments, the solvent is a water-miscible solvent (i.e., the solvent is soluble in water in all proportions). Examples of organic solvents include polar and/or water-miscible solvents, for example, monohydroxy alcohols having from 1 to 4 or more carbon atoms (e.g., methanol, ethanol, isopropanol, propanol, or butanol); polyols such as glycols (e.g., ethylene glycol or propylene glycol), terminal alkanediols (e.g., 1,3-propanediol, 1,4-butanediol, 1,6-hexanediol, or 1,8-octanediol), polyglycols (e.g., diethylene glycol, triethylene glycol, dipropylene glycol, or polypropylene glycol)), triols (e.g., glycerol, trimethylolpropane), or pentaerythritol; ethers such as diethyl ether, methyl t-butyl ether, tetrahydrofuran, p-dioxane, or polyol ethers (e.g., glycol ethers (e.g., ethylene glycol monobutyl ether, diethylene glycol monomethyl ether, dipropylene glycol monomethyl ether, propylene glycol monomethyl ether, 2-butoxyethanol, or those glycol ethers available under the trade designation “DOWANOL” from Dow Chemical Co., Midland, Mich.)); ketones (e.g., acetone or 2-butanone); and combinations thereof.

In some embodiments of the method of treating a hydrocarbon-bearing formation disclosed herein, the solvent comprises at least one of a polyol or polyol ether independently having from 2 to 25 (in some embodiments, 2 to 15, 2 to 10, 2 to 9, or 2 to 8) carbon atoms. In some embodiments, the solvent comprises a polyol. The term “polyol” refers to an organic molecule consisting of C, H, and 0 atoms connected one to another by C—H, C—C, C—O, O—H single bonds, and having at least two C—O—H groups. In some embodiments, useful polyols have 2 to 25, 2 to 20, 2 to 15, 2 to 10, 2 to 8, or 2 to 6 carbon atoms. In some embodiments, the solvent comprises a polyol ether. The term “polyol ether” refers to an organic molecule consisting of C, H, and O atoms connected one to another by C—H, C—C, C—O, O—H single bonds, and which is at least theoretically derivable by at least partial etherification of a polyol. In some embodiments, the polyol ether has at least one C—O—H group and at least one C—O—C linkage. Useful polyol ethers may have from 3 to 25 carbon atoms, 3 to 20, 3 to 15, 3 to 10, 3 to 8, or from 5 to 8 carbon atoms. In some embodiments, the polyol is at least one of ethylene glycol, propylene glycol, poly(propylene glycol), 1,3-propanediol, or 1,8-octanediol, and the polyol ether is at least one of 2-butoxyethanol, diethylene glycol monomethyl ether, ethylene glycol monobutyl ether, dipropylene glycol monomethyl ether, or 1-methoxy-2-propanol. In some embodiments, the polyol and/or polyol ether has a normal boiling point of less than 450° F. (232° C.), which may be useful, for example, to facilitate removal of the polyol and/or polyol ether from a well after treatment. In some embodiments, the solvent comprises at least one of 2-butoxyethanol, ethylene glycol, propylene glycol, poly(propylene glycol), 1,3-propanediol, 1,8-octanediol, diethylene glycol monomethyl ether, ethylene glycol monobutyl ether, or dipropylene glycol monomethyl ether.

In some embodiments of the method of treating a hydrocarbon-bearing formation disclosed herein, the solvent comprises at least one of water, a monohydroxy alcohol, an ether, or a ketone, wherein the monohydroxy alcohol, the ether, and the ketone each independently have up to 4 carbon atoms. Exemplary monohydroxy alcohols having from 1 to 4 carbon atoms include methanol, ethanol, n-propanol, isopropanol, 1-butanol, 2-butanol, isobutanol, and t-butanol. Exemplary ethers having from 2 to 4 carbon atoms include diethyl ether, ethylene glycol methyl ether, tetrahydrofuran, p-dioxane, and ethylene glycol dimethyl ether. Exemplary ketones having from 3 to 4 carbon atoms include acetone, 1-methoxy-2-propanone, and 2-butanone. In some embodiments, useful solvents for practicing the methods disclosed herein comprise at least one of methanol, ethanol, isopropanol, tetrahydrofuran, or acetone.

In some embodiments of the method of treating a hydrocarbon-bearing formation disclosed herein, the treatment compositions comprise at least two organic solvents. In some embodiments, the solvent comprises at least one of a polyol or polyol ether independently having from 2 to 25 (in some embodiments, 2 to 15, 2 to 10, 2 to 9, or 2 to 8) carbon atoms and at least one of water, a monohydroxy alcohol, an ether, or a ketone, wherein the monohydroxy alcohol, the ether, and the ketone each independently have up to 4 carbon atoms. In these embodiments, in the event that a component of the solvent is a member of two functional classes, it may be used as either class but not both. For example, ethylene glycol monomethyl ether may be a polyol ether or a monohydroxy alcohol, but not as both simultaneously. In these embodiments, each solvent component may be present as a single component or a mixture of components. In some embodiments, treatment compositions useful for practicing any of the methods disclosed herein comprise at least one of a polyol or polyol ether independently having from 2 to 25 (in some embodiments, 2 to 15, 2 to 10, 2 to 9, or 2 to 8) carbon atoms and at least one monohydroxy alcohol having up to 4 carbon atoms.

For any of the embodiments of the method of treating a hydrocarbon-bearing formation disclosed herein, wherein the treatment compositions comprise at least one of a polyol or polyol ether independently having from 2 to 25 (in some embodiments, 2 to 15, 2 to 10, 2 to 9, or 2 to 8) carbon atoms, the polyol or polyol ether is present in the composition at at least 50, 55, 60, or 65 percent by weight and up to 75, 80, 85, or 90 percent by weight, based on the total weight of the composition. Exemplary solvent combinations that contain at least one of a polyol or polyol ether include 1,3-propanediol (80%)/isopropanol (IPA) (20%), propylene glycol (70%)/IPA (30%), propylene glycol (90%)/IPA (10%), propylene glycol (80%)/IPA (20%), ethylene glycol (50%)/ethanol (50%), ethylene glycol (70%)/ethanol (30%), propylene glycol monobutyl ether (PGBE) (50%)/ethanol (50%), PGBE (70%)/ethanol (30%), dipropylene glycol monomethyl ether (DPGME) (50%)/ethanol (50%), DPGME (70%)/ethanol (30%), diethylene glycol monomethyl ether (DEGME) (70%)/ethanol (30%), triethylene glycol monomethyl ether (TEGME) (50%)/ethanol (50%), TEGME (70%)/ethanol (30%), 1,8-octanediol (50%)/ethanol (50%), propylene glycol (70%)/tetrahydrofuran (THF) (30%), propylene glycol (70%)/acetone (30%), propylene glycol (70%), methanol (30%), propylene glycol (60%)/IPA (40%), 2-butoxyethanol (80%)/ethanol (20%), 2-butoxyethanol (70%)/ethanol (30%), 2-butoxyethanol (60%)/ethanol (40%), propylene glycol (70%)/ethanol (30%), ethylene glycol (70%)/IPA (30%), and glycerol (70%)/IPA (30%), wherein the exemplary percentages are by weight are based on the total weight of solvent. In some embodiments of the methods disclosed herein, the treatment composition comprises up to 95, 90, 80, 70, 60, 50, 40, 30, 20, or 10 percent by weight of a monohydroxy alcohol having up to 4 carbon atoms, based on the total weight of the treatment composition.

The amount of solvent typically varies inversely with the amount of other components in treatment compositions useful for practicing the present disclosure. For example, based on the total weight of the treatment composition the solvent may be present in the composition in an amount of from at least 10, 20, 30, 40, or 50 percent by weight or more up to 60, 70, 80, 90, 95, 98, or 99 percent by weight, or more.

The ingredients for treatment compositions described herein including fluorinated compounds and solvent can be combined using techniques known in the art for combining these types of materials, including using conventional magnetic stir bars or mechanical mixer (e.g., in-line static mixer and recirculating pump).

Although not wishing to be bound by theory, it is believed that treatment methods for hydrocarbon-bearing formations according to the present disclosure will provide more desirable results when the treatment composition is homogenous at the temperature(s) encountered in the hydrocarbon-bearing formation. Whether the treatment composition is homogeneous at the temperature can depend on many variables (e.g., concentration of the fluorinated compound, solvent composition, brine concentration and composition, hydrocarbon concentration and composition, and the presence of other components (e.g., surfactants)). It is believed that once the treatment composition contacts a hydrocarbon-bearing formation (e.g., downhole), the fluorinated compound will react with at least one of the formation or at least a portion of a plurality of proppants located in a fracture in the formation. Once it has reacted with the formation or at least a portion of a plurality of proppants, the fluorinated compound can modify the wetting properties of the formation and cause an increase in at least one of the gas or oil permeabilities in the formation.

In some embodiments of methods and treated hydrocarbon-bearing formations disclosed herein, the hydrocarbon-bearing formation has brine. The brine present in the formation may be from a variety of sources including at least one of connate water, flowing water, mobile water, immobile water, residual water from a fracturing operation or from other downhole fluids, or crossflow water (e.g., water from adjacent perforated formations or adjacent layers in the formations). The brine may cause water blocking in the hydrocarbon-bearing formation prior to treatment. In some embodiments of the treatment compositions, the solvent at least partially solubilizes or at least partially displaces brine in the hydrocarbon-bearing formation. In some embodiments, the brine has at least 2, 3, 4, 5, 6, 7, 8, 9, or even at least 10 weight percent dissolved salts (e.g., sodium chloride, calcium chloride, strontium chloride, magnesium chloride, potassium chloride, ferric chloride, ferrous chloride, and hydrates thereof), based on the total weight of the brine. Although not wanting to be bound by theory, it is believed that the effectiveness of the methods disclosed herein for improving hydrocarbon productivity of a particular oil and/or gas well having brine accumulated in the near wellbore region will typically be determined by the ability of the treatment composition to dissolve or displace the quantity of brine present in the near wellbore region of the well without causing precipitation of the fluorinated compound or salts. Hence, at a given temperature greater amounts of treatment compositions having lower brine solubility (i.e., treatment compositions that can dissolve a relatively lower amount of brine) will typically be needed than in the case of treatment compositions having higher brine solubility and containing the same fluorinated compound at the same concentration.

In some embodiments of the methods disclosed herein, when the treatment composition treats the hydrocarbon-bearing formation, the hydrocarbon-bearing formation is substantially free of precipitated salt. As used herein, the term “substantially free of precipitated salt” refers to an amount of salt that does not interfere with the ability of the fluorinated ether composition to increase the gas permeability of the hydrocarbon-bearing formation. In some embodiments, “substantially free of precipitated salt” means that no precipitate is visually observed. In some embodiments, “substantially free of precipitated salt” is an amount of salt that is less than 5% by weight higher than the solubility product at a given temperature and pressure.

In some embodiments of methods of treating a hydrocarbon-bearing formation according to the present disclosure, combining the treatment composition and the brine of the hydrocarbon-bearing formation at the temperature of the hydrocarbon-bearing formation does not result in the precipitation of the fluorinated compound. Phase behavior can be evaluated prior to treating the hydrocarbon-bearing formation with the treatment composition by obtaining a sample of the brine from the hydrocarbon-bearing formation and/or analyzing the composition of the brine from the hydrocarbon-bearing formation and preparing an equivalent brine having the same or similar composition to the composition of the brine in the formation. The brine saturation level in a hydrocarbon-bearing formation can be determined using methods known in the art and can be used to determined the amount of brine that can be mixed with the treatment composition. The brine and the treatment composition are combined (e.g., in a container) at the temperature and then mixed together (e.g., by shaking or stirring). The mixture is then maintained at the temperature for 15 minutes, removed from the heat, and immediately visually evaluated to see if cloudiness or precipitation occurs. In some embodiments, the amount of brine that is added before cloudiness or precipitation occurs is at least 5, 10, 15, 20, 25, 30, 35, 40, 45, or at least 50% by weight, based on the total weight of brine and treatment composition combined in the phase behavior evaluation.

The phase behavior of the treatment composition and the brine can be evaluated over an extended period of time (e.g., 1 hour, 12 hours, 24 hours, or longer) to determine if any precipitation or cloudiness is observed. By adjusting the relative amounts of brine (e.g., equivalent brine) and the treatment composition, it is possible to determine the maximum brine uptake capacity (above which precipitation or cloudiness occurs) of the treatment composition at a given temperature. Varying the temperature at which the above procedure is carried out typically results in a more complete understanding of the suitability of treatment compositions for a given well.

In some embodiments of the methods disclosed herein, the hydrocarbon-bearing formation has both liquid hydrocarbons and gas, and the hydrocarbon-bearing formation has at least a gas permeability that is increased after the hydrocarbon-bearing formation is treated with the treatment composition. In some embodiments, the gas permeability after treating the hydrocarbon-bearing formation with the treatment composition is increased by at least 5 percent (in some embodiments, by at least 10, 15, 20, 30, 40, 50, 60, 70, 80, 90, or 100 percent or more) relative to the gas permeability of the formation before treating the formation. In some embodiments, the gas permeability is a gas relative permeability. In some embodiments, the liquid (e.g., oil or condensate) permeability in the hydrocarbon-bearing formation is also increased (in some embodiments, by at least 5, 10, 15, 20, 30, 40, 50, 60, 70, 80, 90, or 100 percent or more) after treating the formation.

In some embodiments, the increase in gas permeability of the treated hydrocarbon-bearing formation is higher than an increase in gas permeability obtained when an equivalent hydrocarbon-bearing formation is treated with the solvent. The term “equivalent hydrocarbon-bearing formation” refers to a hydrocarbon-bearing formation that is similar to or the same (e.g., in chemical make-up, surface chemistry, brine composition, and hydrocarbon composition) as a hydrocarbon-bearing formation disclosed herein before it is treated with a method according to the present disclosure. In some embodiments, both the hydrocarbon-bearing formation and the equivalent hydrocarbon-bearing formation are siliciclastic formations, in some embodiments, greater than 50 percent sandstone. In some embodiments, the hydrocarbon-bearing formation and the equivalent hydrocarbon-bearing formation may have the same or similar pore volume and porosity (e.g., within 15 percent, 10 percent, 8 percent, 6 percent, or even within 5 percent).

The hydrocarbon-bearing formation having both gas and liquid hydrocarbons may have gas condensate, black oil, or volatile oil and may comprise, for example, at least one of methane, ethane, propane, butane, pentane, hexane, heptane, octane, nonane, decane, or higher hydrocarbons. The term “black oil” refers to the class of crude oil typically having gas-oil ratios (GOR) less than about 2000 scf/stb (356 m³/m³). For example, a black oil may have a GOR in a range from about 100 (18), 200 (36), 300 (53), 400 (71), or even 500 scf/stb (89 m³/m³) up to about 1800 (320), 1900 (338), or 2000 scf/stb (356 m³/m³). The term “volatile oil” refers to the class of crude oil typically having a GOR in a range between about 2000 and 3300 scf/stb (356 and 588 m³/m³). For example, a volatile oil may have a GOR in a range from about 2000 (356), 2100 (374), or 2200 scf/stb (392 m³/m³) up to about 3100 (552), 3200 (570), or 3300 scf/stb (588 m³/m³). In some embodiments, the treatment composition at least partially solubilizes or at least partially displaces the liquid hydrocarbons in the hydrocarbon-bearing formation.

Generally, for the treatment methods disclosed herein, the amounts of the fluorinated compound and solvent (and type of solvent) is dependent on the particular application since conditions typically vary between wells, at different depths of individual wells, and even over time at a given location in an individual well. Advantageously, treatment methods according to the present disclosure can be customized for individual wells and conditions. For example, a method of making a treatment composition useful for practicing the methods disclosed herein may include receiving (e.g., obtaining or measuring) data comprising the temperature and at least one of the hydrocarbon composition or the brine composition (including the brine saturation level and components of the brine) of a selected geological zone of a hydrocarbon-bearing formation. These data can be obtained or measured using techniques well known to one of skill in the art. A formulation may then be generated based at least in part on compatibility information concerning the fluorinated compound, the solvent, the temperature, and at least one of the hydrocarbon composition or brine composition of the selected geological zone of the formation. In some embodiments, the compatibility information comprises information concerning phase stability of a mixture of the fluorinated compound, the solvent, and a model brine composition, wherein the model brine composition is based at least partially on the brine composition of the geological zone of the formation. The phase stability of a solution or dispersion can be evaluated using the phase behavior evaluation described above. The phase behavior can be evaluated over an extended period of time (e.g., 1 hour, 12 hours, 24 hours, or longer) to determine if any precipitation or cloudiness is observed. In some embodiments, the compatibility information comprises information concerning solid (e.g., salts or asphaltenes) precipitation from a mixture of the fluorinated compound, the solvent, a model brine composition, and a model hydrocarbon composition, wherein the model brine composition is based at least partially on the brine composition of the geological zone of the formation, and wherein the model hydrocarbon composition is based at least partially on the hydrocarbon composition of the geological zone of the formation. In addition to using a phase behavior evaluation, it is also contemplated that one may be able obtain the compatibility information, in whole or in part, by computer simulation or by referring to previously determined, collected, and/or tabulated information (e.g., in a handbook or a computer database).

The hydrocarbon-bearing formations that may be treated according to the present disclosure may be siliciclastic (e.g., shale, conglomerate, diatomite, sand, and sandstone) or carbonate (e.g., limestone or dolomite) formations. In some embodiments, the hydrocarbon-bearing formation is predominantly sandstone (i.e., at least 50 percent by weight sandstone). In some embodiments, the hydrocarbon-bearing formation is predominantly limestone (i.e., at least 50 percent by weight limestone).

Methods according to the present disclosure may be practiced, for example, in a laboratory environment (e.g., on a core sample (i.e., a portion) of a hydrocarbon-bearing formation or in the field (e.g., on a subterranean hydrocarbon-bearing formation situated downhole). Typically, the methods disclosed herein are applicable to downhole conditions having a pressure in a range from about 1 bar (100 kPa) to about 1000 bars (100 MPa) and have a temperature in a range from about 100° F. (37.8° C.) to 400° F. (204° C.) although the methods are not limited to hydrocarbon-bearing formations having these conditions. Those skilled in the art, after reviewing the instant disclosure, will recognize that various factors may be taken into account in practice of the any of the disclosed methods including the ionic strength of the brine, pH (e.g., a range from a pH of about 4 to about 10), and the radial stress at the wellbore (e.g., about 1 bar (100 kPa) to about 1000 bars (100 MPa)).

In the field, treating a hydrocarbon-bearing formation with a treatment composition described herein can be carried out using methods (e.g., by pumping under pressure) well known to those skilled in the oil and gas art. Coil tubing, for example, may be used to deliver the treatment composition to a particular geological zone of a hydrocarbon-bearing formation. In some embodiments of practicing the methods described herein it may be desirable to isolate a geological zone (e.g., with conventional packers) to be treated with the composition.

Methods according to the present disclosure are useful, for example on both existing and new wells. Typically, it is believed to be desirable to allow for a shut-in time after compositions described herein are treated with the hydrocarbon-bearing formations. Exemplary shut-in times include a few hours (e.g., 1 to 12 hours), about 24 hours, or even a few (e.g., 2 to 10) days. After the treatment composition has been allowed to remain in place for the desired time, the solvent present in the composition may be recovered from the formation by simply pumping fluids up tubing in a well as is commonly done to produce fluids from a formation.

In some embodiments of methods according to the present disclosure, the method comprises treating the hydrocarbon-bearing formation with a fluid prior to treating the hydrocarbon-bearing formation with the treatment composition. In some embodiments, the fluid at least one of at least partially solubilizes or at least partially displaces the brine in the hydrocarbon-bearing formation. In some embodiments, the fluid at least partially solubilizes the brine. In some embodiments, the fluid at least partially displaces the brine. In some embodiments, the fluid at least one of at least partially solubilizes or displaces liquid hydrocarbons in the hydrocarbon-bearing formation. In some embodiments, the fluid is substantially free of fluorinated surfactants. The term “substantially free of fluorinated surfactants” refers to fluid that may have a fluorinated surfactant in an amount insufficient for the fluid to have a cloud point (e.g., when it is below its critical micelle concentration). A fluid that is substantially free of fluorinated surfactant may be a fluid that has a fluorinated surfactant but in an amount insufficient to alter the wettability of, for example, a hydrocarbon-bearing formation under downhole conditions. A fluid that is substantially free of fluorinated surfactant includes those that have a weight percent of such polymers as low as 0 weight percent. The fluid may be useful for decreasing the concentration of at least one of the salts present in the brine prior to introducing the treatment composition to the hydrocarbon-bearing formation. The change in brine composition may change the results of a phase behavior evaluation (e.g., the combination of a treatment composition with a first brine prior to the fluid preflush may result in precipitation of salt or the fluoropolyether compound while the combination of the treatment composition with the brine after the fluid preflush may result in no precipitation.)

In some embodiments of treatment methods disclosed herein, the fluid comprises at least one of toluene, diesel, heptane, octane, or condensate. In some embodiments, the fluid comprises at least one of water, methanol, ethanol, or isopropanol. In some embodiments, the fluid comprises at least one of a polyol or polyol ether independently having from 2 to 25 carbon atoms. In some embodiments, useful polyols have 2 to 20, 2 to 15, 2 to 10, 2 to 8, or 2 to 6 carbon atoms. In some embodiments, useful polyol ethers may have from 3 to 25 carbon atoms, 3 to 20, 3 to 15, 3 to 10, 3 to 8, or from 5 to 8 carbon atoms. Exemplary useful polyols and polyol ethers include any of those described above for solvents. In some embodiments, the fluid comprises at least one monohydroxy alcohol, ether, or ketone independently having up to four carbon atoms. In some embodiments, the fluid comprises at least one of nitrogen, carbon dioxide, or methane.

In some embodiments of the methods and treated hydrocarbon-bearing formations disclosed herein, the hydrocarbon-bearing formation has at least one fracture. In some embodiments, fractured formations have at least 2, 3, 4, 5, 6, 7, 8, 9, or 10 or more fractures. As used herein, the term “fracture” refers to a fracture that is man-made. In the field, for example, fractures are typically made by injecting a fracturing fluid into a subterranean geological formation at a rate and pressure sufficient to open a fracture therein (i.e., exceeding the rock strength). Typically, fracturing refers to hydraulic fracturing, and the fracturing fluid is a hydraulic fluid. Fracturing fluids may or may not contain proppants. Unintentional fracturing can sometimes occur, for example, during drilling of a wellbore. Unintentional fractures can be detected (e.g., by fluid loss from the wellbore) and repaired. Typically, fracturing a hydrocarbon-bearing formation refers to intentionally fracturing the formation after the wellbore is drilled.

In some embodiments of the methods disclosed herein, wherein treating the formation with the composition provides an increase in at least one of the gas permeability or the liquid permeability of the formation, the formation is a non-fractured formation (i.e., free of man-made fractures made by the process described above). Advantageously, treatment methods disclosed herein typically provide an increase in at least one of the gas permeability or the hydrocarbon liquid permeability of the formation without fracturing the formation.

In some embodiments of the methods and treated hydrocarbon-bearing formations disclosed herein, wherein the hydrocarbon-bearing formation has at least one fracture, the fracture has a plurality of proppants therein. Prior to delivering the proppants into a fracture, the proppants may be treated with a fluoropolyether compound or may be untreated (e.g., may comprise less than 0.1% by weight fluoropolyether compound, based on the total weight of the plurality of proppants). In some embodiments, the fluoropolyether compound useful in practicing the present disclosure is adsorbed on at least a portion of the plurality of proppants.

Exemplary proppants known in the art include those made of sand (e.g., Ottawa, Brady or Colorado Sands, often referred to as white and brown sands having various ratios), resin-coated sand, sintered bauxite, ceramics (i.e., glasses, crystalline ceramics, glass-ceramics, and combinations thereof), thermoplastics, organic materials (e.g., ground or crushed nut shells, seed shells, fruit pits, and processed wood), and clay. Sand proppants are available, for example, from Badger Mining Corp., Berlin, Wis.; Borden Chemical, Columbus, Ohio; and Fairmont Minerals, Chardon, Ohio. Thermoplastic proppants are available, for example, from the Dow Chemical Company, Midland, Mich.; and BJ Services, Houston, Tex. Clay-based proppants are available, for example, from CarboCeramics, Irving, Tex.; and Saint-Gobain, Courbevoie, France. Sintered bauxite ceramic proppants are available, for example, from Borovichi Refractories, Borovichi, Russia; 3M Company, St. Paul, Minn.; CarboCeramics; and Saint Gobain. Glass bubble and bead proppants are available, for example, from Diversified Industries, Sidney, British Columbia, Canada; and 3M Company.

Proppants useful in practicing the present disclosure may have a particle size in a range from 100 micrometers to 3000 micrometers (i.e., about 140 mesh to about 5 mesh (ANSI)) (in some embodiments, in a range from 1000 micrometers to 3000 micrometers, 1000 micrometers to 2000 micrometers, 1000 micrometers to 1700 micrometers (i.e., about 18 mesh to about 12 mesh), 850 micrometers to 1700 micrometers (i.e., about 20 mesh to about 12 mesh), 850 micrometers to 1200 micrometers (i.e., about 20 mesh to about 16 mesh), 600 micrometers to 1200 micrometers (i.e., about 30 mesh to about 16 mesh), 425 micrometers to 850 micrometers (i.e., about 40 to about 20 mesh), or 300 micrometers to 600 micrometers (i.e., about 50 mesh to about 30 mesh).

In some embodiments of methods of treating fractured formations, the proppants form packs within a formation and/or wellbore. Proppants may be selected to be chemically compatible with the solvents and compositions described herein. The term “proppant” as used herein includes fracture proppant materials introducible into the formation as part of a hydraulic fracture treatment and sand control particulate introducible into the wellbore or formation as part of a sand control treatment such as a gravel pack or frac pack.

In some embodiments, methods according to the present disclosure include treating the hydrocarbon-bearing formation with the composition at least one of during fracturing or after fracturing the hydrocarbon-bearing formation. In some of these embodiments, the fracturing fluid, which may contain proppants, may be aqueous (e.g., a brine) or may contain predominantly organic solvent (e.g., an alcohol or a hydrocarbon). In some embodiments, it may be desirable for the fracturing fluid to include viscosity enhancing agents (e.g., polymeric viscosifiers), electrolytes, corrosion inhibitors, scale inhibitors, and other such additives that are common to a fracturing fluid.

In some embodiments of methods of treating fractured formations, the amount of the composition introduced into the fractured formation is based at least partially on the volume of the fracture(s). The volume of a fracture can be measured using methods that are known in the art (e.g., by pressure transient testing of a fractured well). Typically, when a fracture is created in a hydrocarbon-bearing subterranean formation, the volume of the fracture can be estimated using at least one of the known volume of fracturing fluid or the known amount of proppant used during the fracturing operation. Coil tubing, for example, may be used to deliver the treatment composition to a particular fracture. In some embodiments, in practicing the methods disclosed herein it may be desirable to isolate the fracture (e.g., with conventional packers) to be treated with the treatment composition.

In some embodiments, wherein the formation treated according to the methods described herein has at least one fracture, the fracture has a conductivity, and after the treatment composition treats at least one of the fracture or at least a portion of the plurality of proppants, the conductivity of the fracture is increased (e.g., by 25, 50, 75, 100, 125, 150, 175, 200, 225, 250, 275, or by 300 percent).

Fluorinated compounds according to the present disclosure may also be useful, for example, for treating proppants before using the proppants in a fracturing and propping operation. Treated proppants may be prepared, for example, by dissolving or dispersing the fluoropolyether compound in a dispersing medium (e.g., water and/or organic solvent (e.g., alcohols, ketones, esters, alkanes and/or fluorinated solvents (e.g., hydrofluoroethers and/or perfluorinated carbons)) that is then applied to the particles. Optionally, a catalyst can be added (e.g., a acid or base). The amount of liquid medium used should be sufficient to allow the solution or dispersion to generally evenly wet the proppants being treated. Typically, the concentration of the fluoropolyether compound in the solution or dispersion is the range from about 5% to about 20% by weight, although amounts outside of this range may also be useful. The proppants are typically treated with the fluorinated compound solution or dispersion at temperatures in the range from about 25° C. to about 50° C., although temperatures outside of this range may also be useful. The treatment solution or dispersion can be applied to the proppants using techniques known in the art for applying solutions or dispersions to proppants (e.g., mixing the solution or dispersion and proppants in a vessel (in some embodiments under reduced pressure) or spraying the solutions or dispersions onto the particles). After application of the treatment solution or dispersion to the particles, the liquid medium can be removed using techniques known in the art (e.g., drying the particles in an oven). Typically, about 0.1 to about 5 (in some embodiments, for example, about 0.5 to about 2) percent by weight fluorinated compound is added to the particles, although amounts outside of this range may also be useful.

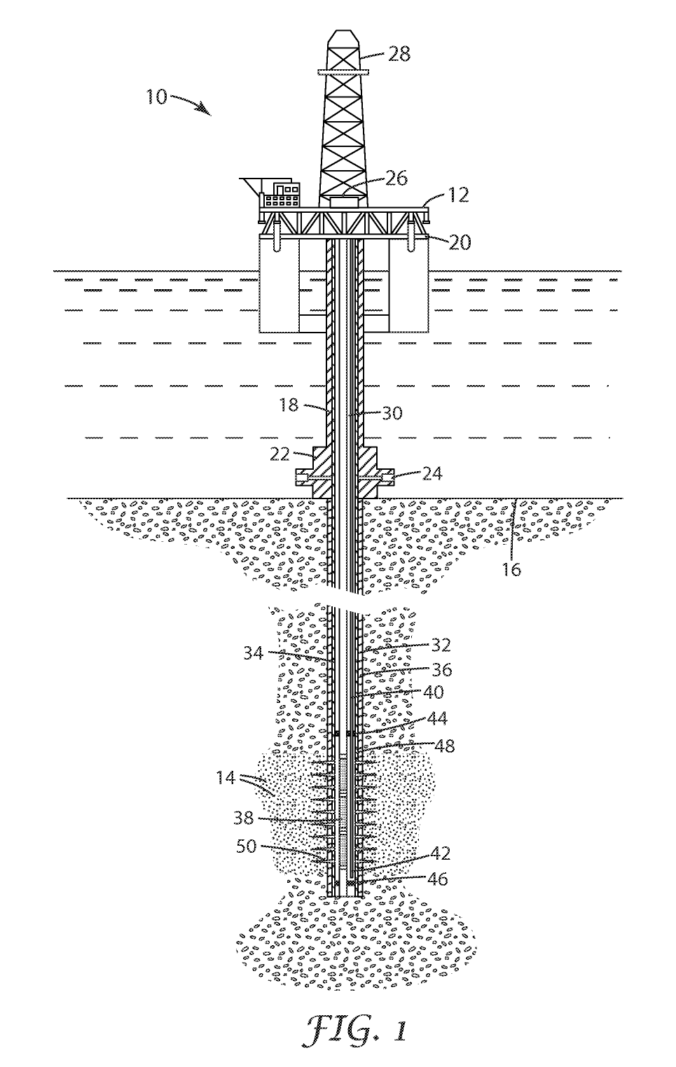

Referring to FIG. 1, an exemplary offshore oil platform is schematically illustrated and generally designated 10. Semi-submersible platform 12 is centered over submerged hydrocarbon-bearing formation 14 located below sea floor 16. Subsea conduit 18 extends from deck 20 of platform 12 to wellhead installation 22 including blowout preventers 24. Platform 12 is shown with hoisting apparatus 26 and derrick 28 for raising and lowering pipe strings such as work string 30.

Wellbore 32 extends through the various earth strata including hydrocarbon-bearing formation 14. Casing 34 is cemented within wellbore 32 by cement 36. Work string 30 may include various tools including, for example, sand control screen assembly 38 which is positioned within wellbore 32 adjacent to hydrocarbon-bearing formation 14. Also extending from platform 12 through wellbore 32 is fluid delivery tube 40 having fluid or gas discharge section 42 positioned adjacent to hydrocarbon-bearing formation 14, shown with production zone 48 between packers 44, 46. When it is desired to treat the near-wellbore region of hydrocarbon-bearing formation 14 adjacent to production zone 48, work string 30 and fluid delivery tube 40 are lowered through casing 34 until sand control screen assembly 38 and discharge section 42 are positioned adjacent to the near-wellbore region of hydrocarbon-bearing formation 14 including perforations 50. Thereafter, a composition described herein is pumped down delivery tube 40 to progressively treat the near-wellbore region of hydrocarbon-bearing formation 14.

While the drawing depicts an offshore operation, the skilled artisan will recognize that the methods for treating a production zone of a wellbore are equally well-suited for use in onshore operations. Also, while the drawing depicts a vertical well, the skilled artisan will also recognize that methods according to the present disclosure are equally well-suited for use in deviated wells, inclined wells or horizontal wells.

Advantages and embodiments of the methods disclosed herein are further illustrated by the following examples, but the particular materials and amounts thereof recited in these examples, as well as other conditions and details, should not be construed to unduly limit this disclosure. Unless otherwise noted, all parts, percentages, ratios, etc. in the examples and the rest of the specification are by weight. In the Tables, “nd” means not determined.

### EXAMPLES

In the following examples, all reagents were obtained from Sigma-Aldrich, St. Louis, Mo., or Bornem, Belgium, unless indicated otherwise. All percentages and ratios reported are by weight unless indicated otherwise.

### Silane Examples 1 to 12

### Example 1

### CF₃OCF₂CF₂CF₂OCF₂C(O)NHCH₂CH₂CH₂Si(OCH₃)₃

### Part A

The methyl ester of perfluoro-3,7-dioxaoctanoic acid (CF₃OCF₂CF₂CF₂OCF₂C(O)OCH₃) was prepared according to the method described in U.S. Pat. App. Pub. No. 2007/0015864 (Hintzer et al.) in the Preparation of Compound 1, the disclosure of which preparation is herein by reference.

### Part B

In a three-necked 100-mL flask fitted with a stirrer, thermometer, and condenser were placed 18 grams (0.05 mole) of the methyl ester from Part A and (3-aminopropyl)trimethoxysilane (APTMS) (10.1 grams of 97% pure material, 0.05 mole). The reaction mixture was heated under nitrogen at 50° C. using a heating mantle for two hours. Methanol was then removed under reduced pressure. A clear, yellow, slightly viscous liquid was obtained, which was identified to be

CF₃OCF₂CF₂CF₂OCF₂C(O)NHCH₂CH₂CH₂Si(OCH₃)₃ using nuclear magnetic resonance (NMR) spectroscopy and infrared (IR) spectroscopy.

### Example 2

CF₃OCF₂CF₂CF₂OCF₂C(O)NHCH₂CH₂CH₂Si(OCH₂CH₃)₃

Example 2 was prepared according to the method of Example 1 except (3-aminopropyl)triethoxysilane (APTES) (11.4 grams of 99% pure material, 0.05 mole) was used instead of APTMS to provide

CF₃OCF₂CF₂CF₂OCF₂C(O)NHCH₂CH₂CH₂Si(OCH₂CH₃)₃.

### Example 3

### CF₃OCF₂CF₂CF₂OCHFCF₂C(O)NHCH₂CH₂CH₂Si(OCH₃)₃

### Part A

The methyl ester of 3-H-perfluoro-4,8-dioxanonanoic acid (CF₃O(CF₂)₃OCHFCF₂COOCH₃) was prepared according to the method described in the synthesis of compound 2 in U.S. Pat. App. Pub. No. 2007/0142541 (Hintzer et al.); the disclosure of this synthesis is herein by reference.

### Part B

The method of Part B of Example 1 was followed except using 19.6 grams of CF₃O(CF₂)₃OCHFCF₂COOCH₃ instead of CF₃OCF₂CF₂CF₂OCF₂C(O)OCH₃.

### Example 4

### CF₃CF₂CF₂OCHFCF₂C(O)NHCH₂CH₂CH₂Si(OCH₃)₃

### Part A

The methyl ester of 3-H-perfluoro-4-oxaheptanoic acid (C₃F₇OCHFCF₂COOCH₃) was prepared according to the method described in the synthesis of compound 4 in U.S. Pat. App. Pub. No. 2007/0142541 (Hintzer et al.); the disclosure of this synthesis is herein by reference.

### Part B

The method of Part B of Example 1 was followed except using 16.3 grams of CF₃CF₂CF₂OCHFCF₂COOCH₃ instead of CF₃OCF₂CF₂CF₂OCF₂C(O)OCH₃.

### Example 5

### CF₃OCF₂OCF₂OCF₂OCF₂C(O)NHCH₂CH₂CH₂Si(OCH₃)₃

### Part A

The methyl ester of perfluoro-3,5,7,9-tetraoxadecanoic acid (obtained from Anles Ltd., St. Petersburg, Russia) was prepared by esterification in methanol using 50% aqueous sulfuric acid. Flash distillation of the reaction mixture resulted in a two-phase distillate. The lower phase was fractionally distilled to provide

CF₃OCF₂OCF₂OCF₂OCF₂COOCH₃.

### Part B

The method of Part B of Example 1 was followed except using 19.6 grams of CF₃OCF₂OCF₂OCF₂OCF₂COOCH₃ instead of CF₃OCF₂CF₂CF₂OCF₂C(O)OCH₃.

### Example 6

CF₃OCF₂OCF₂OCF₂OCF₂C(O)NHCH₂CH₂CH₂Si(OCH₂CH₃)₃

The method of Example 2 was followed except using 19.6 grams of CF₃OCF₂OCF₂OCF₂OCF₂COOCH₃, prepared as described in Part A of Example 5, instead of CF₃OCF₂CF₂CF₂OCF₂C(O)OCH₃.

### Example 7

### CF₃OCF₂CF₂CF₂OCHFC(O)NHCH₂CH₂CH₂Si(OCH₃)₃

### Part A

The methyl ester of 2-H-perfluoro-3,7-dioxaoctanoic acid (CF₃OCF₂CF₂CF₂OCHFCOOCH₃) was prepared according to the method described in the synthesis of compound 3 (paragraph [0062]) in U.S. Pat. App. Pub. No. 2007/0142541 (Hintzer et al.); the disclosure of this synthesis is herein by reference.

### Part B

The method of Part B of Example 1 was followed except using 18 grams of CF₃OCF₂CF₂CF₂OCHFCOOCH₃ instead of CF₃OCF₂CF₂CF₂OCF₂C(O)OCH₃.

### Example 8

### CF₃CF₂CF₂OCHFC(O)NHCH₂CH₂CH₂Si(OCH₃)₃

### Part A

The methyl ester of 2-H-perfluoro-3-oxahexanoic acid (CF₃CF₂CF₂OCHFCOOCH₃) was prepared according to the method described in the synthesis of compound 5 in U.S. Pat. App. Pub. No. 2007/0142541 (Hintzer et al.); the disclosure of this synthesis is herein by reference.

### Part B

The method of Part B of Example 1 was followed except using 13.8 grams of CF₃CF₂CF₂OCHFCOOCH₃ instead of CF₃OCF₂CF₂CF₂OCF₂C(O)OCH₃.

### Example 9

CF₃OCF₂CF₂CF₂OCF₂C(O)NHCH₂CH₂OC(O)NHCH₂CH₂CH₂Si(OCH₂CH₃)₃

### Part A

In a three-necked 100-mL flask fitted with a stirrer, thermometer, and condenser were placed 18 grams (0.05 mole) of CF₃OCF₂CF₂CF₂OCF₂C(O)OCH₃, prepared in Example 1, Part A, and ethanolamine (3.1 grams, 0.05 mole) under a nitrogen atmosphere. The reaction mixture was heated under nitrogen at 50° C. using a heating mantle for two hours. Methanol was then removed under reduced pressure. A clear, yellow, slightly viscous liquid was obtained, which was identified to be

CF₃OCF₂CF₂CF₂OCF₂C(O)NHCH₂CH₂OH using NMR and IR spectroscopy.

### Part B

The material from Part A was diluted with 31 grams of methyl ethyl ketone (MEK), and 12.4 grams (0.05 mole) of 3-isocyanatopropyltriethoxysilane and one drop of tin(II) 2-ethylhexanoate were added. The reaction mixture was heated at 80° C. for 16 hours. A clear yellow solution of

CF₃OCF₂CF₂CF₂OCF₂C(O)NHCH₂CH₂OC(O)NHCH₂CH₂CH₂Si(OCH₂CH₃)₃ was obtained. The solution was analyzed by IR spectroscopy, and no residual NCO group was detected.

### Example 10

CF₃OCF₂OCF₂OCF₂OCF₂C(O)NHCH₂CH₂OC(O)NHCH₂CH₂CH₂Si(OCH₂CH₃)₃

Example 10 was prepared using the method of Example 9 except using 19.6 grams (0.05 mole) CF₃OCF₂OCF₂OCF₂OCF₂COOCH₃, prepared in Part A of Example 5, instead of CF₃OCF₂CF₂CF₂OCF₂C(O)OCH₃ in Part A.

### Example 11

CF₃OCF₂CF₂CF₂OCF₂C(O)NHCH₂CH₂OCH₂CH₂CH₂Si(OCH₃)₃

### Part A

CF₃OCF₂CF₂CF₂OCF₂C(O)NHCH₂CH₂OH was prepared according to the method of Example 9, Part A.

### Part B

A 30% solution of sodium methoxide in methanol (9 grams, 0.05 mole) was added to the material from Part A, and the reaction mixture was heated for about one hour at 60° C. under nitrogen. Methanol was removed under reduced pressure. 3-Chloropropyltrimethoxysilane (9.9 grams, 0.05 mole) was added and the reaction mixture was heated for six hours at 60° C. under nitrogen. MEK (32 grams) was added, and the reaction mixture was filtered to provide a clear, amber solution of

CF₃OCF₂CF₂CF₂OCF₂C(O)NHCH₂CH₂OCH₂CH₂CH₂Si(OCH₃)₃.

### Example 12

CF₃OCF₂OCF₂OCF₂OCF₂C(O)NHCH₂CH₂OC(O)NHCH₂CH₂CH₂Si(OCH₂CH₃)₃

### Part A

CF₃OCF₂OCF₂OCF₂OCF₂C(O)NHCH₂CH₂OH was prepared using the method of Example 9, Part A except using 19.6 grams (0.05 mole)

CF₃OCF₂OCF₂OCF₂OCF₂COOCH₃, prepared in Part A of Example 5, instead of CF₃OCF₂CF₂CF₂OCF₂C(O)OCH₃.

### Part B

CF₃OCF₂OCF₂OCF₂OCF₂C(O)NHCH₂CH₂OC(O)NHCH₂CH₂CH₂Si(OCH₂CH₃)₃ was prepared using the method of Part B of Example 11 except starting with CF₃OCF₂OCF₂OCF₂OCF₂C(O)NHCH₂CH₂OH, prepared in Part A.

### Comparative Example A

Comparative Example A was prepared according to the method of Example 1 except (3-aminopropyl)triethoxysilane (APTES) (11.4 grams of 99% pure material, 0.05 mole) was used instead of APTMS and 16.3 grams (0.05 mole) of CF₃CF₂CF₂OCF(CF₃)COOCH₃ (obtained, and formerly available, from Hoechst AG, Germany as the methyl ester of perfluoro-(beta-propoxy)-propionic acid) instead of CF₃OCF₂CF₂CF₂OCF₂C(O)OCH₃ to provide CF₃CF₂CF₂OCF(CF₃)C(O)NHCH₂CH₂CH₂Si(OCH₂CH₃)₃.

### Examples 13 to 24 and Contact Angle Measurements

Each of Silane Examples 1 to 12 and Comparative Example A (10 grams each) was mixed with 40 grams tetraethylorthosilicate, 10 grams of 37% hydrochloric acid, and 940 grams ethanol. Each formulation was sprayed onto white glazed sanitary tiles, obtained from Ideal Standard, Wittlich, Germany. The pressure during spraying was about 2 bar (2×10⁵ Pa), the flow about 40 mL/minute, and the add-on about 150 mL/m². Each tile was allowed to dry at room temperature for 24 hours.

For Comparative Example B, a solution containing 10 grams of a 10% by weight fluorinated disilane solution (obtained from from 3M Company, St. Paul, Minn., under the trade designation “3M EASY CLEAN COATING ECC-4000”), 10 grams of 37% hydrochloric acid, and 980 grams ethanol was prepared. This solution was sprayed onto white glazed sanitary tiles as described above.

Static contact angles were measured versus water and hexadecane using a contact angle measuring instrument obtained from Kruss GmbH, Hamburg, Germany, under the trade designation “DSA 100”.

For each of Examples 13 to 24, the samples were subjected to 40 cycles of abrasion treatment using an Erichsen cleaning machine (obtained from DCI, Belgium), with an abrasive cleaner obtained from Unilever, London, England, under the trade designation “CIF”), and wipe obtained from 3M Company under the trade designation “3M High Performance Wipe”. Contact angles were then measured again. The results are shown in Table 1, below.

TABLE 1

| | | Initial | Contact angles after |
|---|---|---|---|
| | | contact angles, | abrasion, |
| Example | Silane Example | water/hexadecane | water/hexadecane |
| Example 13 | Example 1 | 100/66 | 67/46 |
| Example 14 | Example 2 | 104/62 | 72/47 |
| Example 15 | Example 3 | 101/68 | 64/43 |
| Example 16 | Example 4 | 102/66 | 67/43 |
| Example 17 | Example 5 | 107/68 | 73/50 |
| Example 18 | Example 6 | 110/65 | 70/52 |
| Example 19 | Example 7 | 104/63 | 68/49 |
| Example 20 | Example 8 | 100/58 | 63/40 |
| Example 21 | Example 9 | 102/64 | 69/50 |
| Example 22 | Example 10 | 105/67 | 70/51 |
| Example 23 | Example 11 | 100/58 | 65/44 |
| Example 24 | Example 12 | 103/60 | 66/46 |
| Comp. Ex. A | Comp. Ex. A | 102/65 | 61/40 |
| Comp. Ex. B | Comp. Ex. B | 105/63 | 99/59 |

### Examples 25 to 36

Examples 25 to 36 were prepared using the method of Examples 12 to 24 except using flat glass (obtained from Aqua Production, France) instead of ceramic tiles, and each using a formulation containing 2 grams of 37% hydrochloric acid instead of 10 grams of 37% hydrochloric acid. For Examples 25 to 36, the abrasion treatment of Examples 12 to 24 was carried out except using a sponge instead of a wipe and using 4000 cleaning cycles instead of 40 cleaning cycles. The results are shown in Table 2, below.

TABLE 2

| | | Initial | Contact angles after |
|---|---|---|---|
| | | contact angles, | abrasion, |
| Example | Silane Example | water/hexadecane | water/hexadecane |
| Example 25 | Example 1 | 109/72 | 107/63 |
| Example 26 | Example 2 | 108/68 | 102/61 |
| Example 27 | Example 3 | 94/66 | 93/60 |
| Example 28 | Example 4 | 93/67 | 93/52 |
| Example 29 | Example 5 | 112/72 | 103/65 |
| Example 30 | Example 6 | 116/70 | 105/62 |
| Example 31 | Example 7 | 108/67 | 98/56 |
| Example 32 | Example 8 | 94/61 | 90/54 |
| Example 33 | Example 9 | 105/70 | 100/63 |
| Example 34 | Example 10 | 107/65 | 98/58 |
| Example 35 | Example 11 | 100/62 | 93/57 |
| Example 36 | Example 12 | 103/63 | 96/55 |
| Comp. Ex. A | Comp. Ex. A | 95/63 | 85/54 |
| Comp. Ex. B | Comp. Ex. B | 104/64 | 106/62 |

### Dynamic Contact Angle on Glass

For Examples 25 to 32, dynamic advancing and receding contact angles were also measured prior to abrasion treatment using a Kruss DSA 100 (obtained from Kruss GmbH). The results are summarized in Table 3, below.

TABLE 3

| | | Advancing/ | |
|---|---|---|---|
| | Fluorochemical | Receding | Advancing/Receding |
| Substrate | material | CA with water | CA with hexadecane |
| Example 25 | Example 1 | 110/76 | 81/63 |
| Example 26 | Example 2 | 116/84 | 78/65 |
| Example 27 | Example 3 | 115/87 | 84/66 |
| Example 28 | Example 4 | 100/65 | 75/58 |
| Example 29 | Example 5 | 118/88 | 86/63 |
| Example 30 | Example 6 | 112/83 | 82/61 |
| Example 31 | Example 7 | 114/87 | 77/55 |
| Example 32 | Example 8 | 103/78 | 68/49 |
| Comp. Ex. A | Comp. Ex. A | 100/82 | 70/47 |
| Comp. Ex. B | Comp. Ex. B | 113/95 | 71/61 |

### Examples 37 to 41

### Hydrocarbon-Bearing Formation Treatment Composition Preparation:

Hydrocarbon-Bearing Formation Treatment Compositions 1 to 3 were prepared by combining the Silane Examples shown in Table 4, below, with 2 solvents, shown in Table 4, below. The components were mixed together using a magnetic stirrer and a magnetic stir bar. The weight percentages of each of the components after mixing are shown in Table 4, below.

TABLE 4

| Formation | | | |
|---|---|---|---|
| Treatment | Silane Example | Solvent 1 | |
| Composition | (wt. %) | (wt. %) | Solvent 2 |
| 1 | Example 1 (1) | 2-butoxy | Ethanol |
| | | ethanol | (29.5) |
| | | (69.5) | |
| 2 | Example 3 (1) | 2-butoxy | Ethanol |
| | | ethanol | (29.5) |
| | | (69.5) | |
| 3 | Example 9 | Ethanol (99) | none |
| | (1) | | |

### Flow Setup and Procedure for Examples 37 and 38:

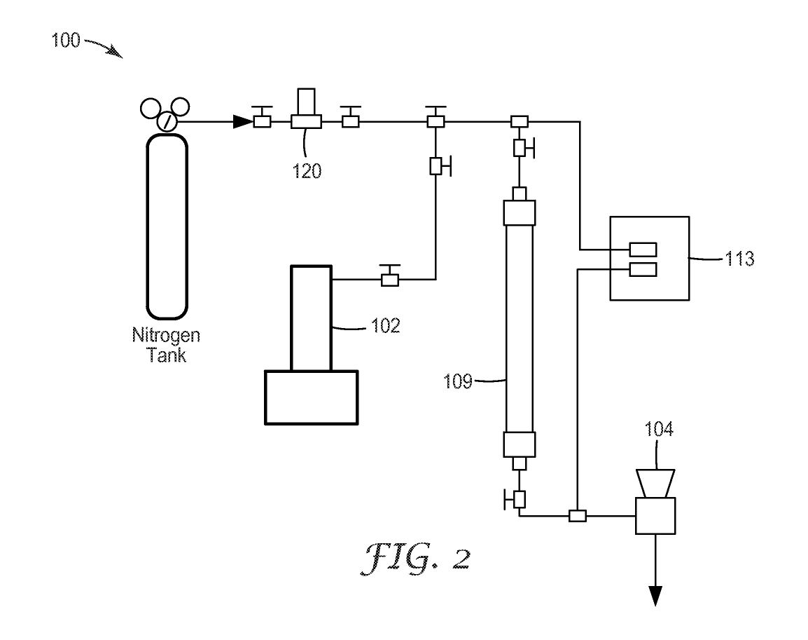

A schematic diagram of a flow apparatus 100 used to determine relative permeability of sea sand or calcium carbonate is shown in FIG. 2. Flow apparatus 100 included positive displacement pump 102 (Model Gamma/4-W 2001 PP, obtained from Prolingent AG, Regensdorf, Germany) to inject n-heptane at constant rate. Nitrogen gas was injected at constant rate through a gas flow controller 120 (Model DK37/MSE, Krohne, Duisburg, Germany). Pressure indicators 113, obtained from Siemens under the trade designation “SITRANS P” 0-16 bar, were used to measure the pressure drop across a sea sand pack in vertical stainless steel core holder 109 (20 cm by 12.5 cm²) (obtained from 3M Company, Antwerp, Belgium). A back-pressure regulator (Model No. BS(H)2; obtained from RHPS, The Netherlands) 104 was used to control the flowing pressure upstream and downstream of core holder 109. Core holder 109 was heated by circulating silicone oil, heated by a heating bath obtained from Lauda, Switzerland, Model R22.

The core holder was filled with sea sand (obtained from Aldrich, Bornem, Belgium, grade 60-70 mesh) and then heated to 75° C. The temperature of 75° C. was maintained for each of the flows described below. A pressure of about 5 bar (5×10⁵ Pa) was applied, and the back pressure was regulated in such a way that the flow of nitrogen gas through the sea sand was about 500 to 1000 mL/minute. The initial gas permeability was calculated using Darcy's law.

Synthetic brine according to the natural composition of North Sea brine was prepared by mixing 5.9% sodium chloride, 1.6% calcium chloride, 0.23% magnesium chloride, and 0.05% potassium chloride and distilled water up to 100% by weight. The brine was introduced into the core holder at about 1 mL/minute using displacement pump 102.

Heptane was then introduced into the core holder at about 0.5 mL/minute using displacement pump 102. Nitrogen and n-heptane were co-injected into the core holder until steady state was reached.

The treatment composition was then injected into the core at a flow rate of 1 mL/minute for about one pore volume. The gas permeability after treatment was calculated from the steady state pressure drop, and improvement factor was calculated as the permeability after treatment/permeability before treatment.

Heptane was then injected for about four to six pore volumes. The gas permeability and improvement factor were again calculated.

For Examples 37 to 38, the liquid used for each injection, the initial pressure, the pressure change (ΔP), the flow rate for each injection, the amount of liquid used for each injection, the flow rate of gas through the core (Q), the gas permeability (K), and the improvement factor (PI) are shown in Table 5, below.

### Control Example A

Control Example A was carried out according to the method of Examples 37 to 38 with the exception that the treatment composition contained only 2-butoxyethanol (70% by weight) and ethanol (30% by weight). The liquid used for each injection, the initial pressure, the pressure change (ΔP), the flow rate for each injection, the amount of liquid used for each injection, the flow rate of gas through the core (Q), the gas permeability (K), and the improvement factor (PI) are shown in Table 5, below.

TABLE 5

| | | Pressure | | Flow | Amount | Q | K | |
|---|---|---|---|---|---|---|---|---|
| Example | Liquid | (initial) | ΔP | (mL/min) | Liquid (g) | (mL/sec) | (Darcy) | PI |
| 37 | none | 5.1 | 0.01 | 600 | none | 10 | 27.2 | |
| | brine | 5.2 | 0.07 | 630 | 55 | 10.9 | 4.5 | |
| | heptane | 5.5 | 0.06 | 480 | 55 | 8.2 | 3.7 | |
| | Treatment | 5.4 | 0.03 | 360 | 100 | 6.1 | 6.1 | 1.6 |
| | Comp. 1 | | | | | | | |
| | heptane | 5.1 | 0.03 | 420 | 150 | 7.1 | 7.7 | 2.1 |
| 38 | none | 5.1 | 0.01 | 690 | none | 11.5 | 31.3 | |
| | brine | 5.9 | 0.06 | 590 | 50 | 10.1 | 4.7 | |
| | heptane | 5.9 | 0.06 | 630 | 55 | 10.8 | 4.9 | |
| | Treatment | 6.0 | 0.03 | 630 | 110 | 10.7 | 9.7 | 2.0 |
| | Comp. 2 | | | | | | | |
| | heptane | 5.4 | 0.03 | 660 | 110 | 11.1 | 12.1 | 2.5 |
| Control | none | 5.2 | 0.01 | 860 | none | 14.3 | 38.9 | |
| A | brine | 5.5 | 0.15 | 650 | 55 | 11.6 | 2.2 | |
| | heptane | 5.4 | 0.13 | 400 | 65 | 7.1 | 1.4 | |
| | 2-butoxy- | 5.6 | 0.09 | 400 | 150 | 6.9 | 2.0 | 1.4 |
| | ethanol/ | | | | | | | |
| | ethanol | | | | | | | |
| | heptane | 5.5 | 0.14 | 420 | 130 | 7.6 | 1.5 | 1.03 |

### Examples 39 to 40

Examples 39 to 40 were carried out according to the method of Examples 37 to 38, except that no heptane flows were carried out.

For Examples 39 to 40, the liquid used for each injection, the initial pressure, the pressure change (ΔP), the flow rate for each injection, the amount of liquid used for each injection, the flow rate of gas through the core (Q), the gas permeability (K), and the improvement factor (PI) are shown in Table 6, below.

TABLE 6

| | | Pressure | | Flow | Amount | Q | K | |
|---|---|---|---|---|---|---|---|---|
| Example | Liquid | (initial) | ΔP | (mL/min) | Liquid (g) | (mL/sec) | (Darcy) | PI |
| 39 | none | 5.4 | 0.01 | 780 | none | 13 | 35.4 | |
| | brine | 5.5 | 0.08 | 720 | 55 | 12.5 | 4.5 | |
| | Treatment | 5.8 | 0.04 | 820 | 100 | 13.9 | 9.2 | 2.0 |
| | Comp. 1 | | | | | | | |
| | brine | 5.6 | 0.05 | 1220 | 200 | 21 | 11.9 | 2.6 |
| 40 | none | 5.0 | 0.01 | 850 | none | 14.3 | 38.5 | |
| | brine | 5.9 | 0.09 | 1100 | 185 | 19 | 5.6 | |
| | Treatment | 6.0 | 0.05 | 1220 | 100 | 20.7 | 12 | 2.1 |
| | Comp. 2 | | | | | | | |
| | brine | 6.1 | 0.05 | 1220 | 260 | 20.7 | 12.2 | 2.2 |
| Control | None | 5.4 | 0.01 | 950 | none | 15.8 | 43 | |
| B | Brine | 5.9 | 0.1 | 1200 | 155 | 21 | 5.6 | |
| | Treatment | 6.3 | 0.05 | 1000 | 150 | 17.1 | 9.8 | 1.75 |
| | Comp. | | | | | | | |
| | Control B | | | | | | | |
| | brine | 6.4 | 0.05 | 950 | 80 | 16.1 | 8.8 | 1.6 |
| | brine | 6.4 | 0.1 | 820 | 180 | 14.4 | 4.1 | 0.7 |

### Control Example B

Control Example B was carried out according to the method of Examples 35 to 36 with the exception that the treatment composition contained 1% by weight cocoamidopropylsulfobetaine, obtained from SEPPIC, France, under the trade designation “AMONYL 675 SB”, 2-butoxyethanol (69.5% by weight) and ethanol (29.5% by weight). The liquid used for each injection, the initial pressure, the pressure change (ΔP), the flow rate for each injection, the amount of liquid used for each injection, the flow rate of gas through the core (Q), the gas permeability (K), and the improvement factor (PI) are shown in Table 6, above.

### Example 41

Example 41 was carried out according to the method of Examples 37 to 38, except that particulate calcium carbonate (obtained from Merck, Darmstadt, Germany as granular marble, particle size in a range from 0.5 mm to 2 mm) was used instead of sea sand.

The liquid used for each injection, the initial pressure, the pressure change (ΔP), the flow rate for each injection, the amount of liquid used for each injection, the flow rate of gas through the core (Q), the gas permeability (K), and the improvement factor (PI) are shown in Table 7, below.

TABLE 7

| | | Pressure | | Flow | Amount | | | |
|---|---|---|---|---|---|---|---|---|
| Example | Liquid | (initial) | ΔP | (mL/min) | Liquid (g) | Q | K | PI |
| 41 | none | 5.1 | 0.01 | 470 | none | 7.8 | 21.3 | |
| | brine | 5.2 | 0.13 | 500 | 50 | 8.9 | 1.8 | |
| | heptane | 5.4 | 0.13 | 300 | 80 | 5.4 | 1.1 | |
| | Treatment | 5.3 | 0.06 | 360 | 40 | 6.2 | 3.0 | 2.7 |
| | Comp. 3 | | | | | | | |
| | heptane | 5.0 | 0.06 | 320 | 180 | 5.5 | 2.4 | 2.2 |
| Control | none | 5.0 | 0.01 | 580 | none | 9.7 | 26.3 | |
| Ex. C | brine | 5.4 | 0.15 | 500 | 48 | 9.0 | 1.6 | |
| | heptane | 5.4 | 0.11 | 420 | 60 | 7.4 | 1.9 | |
| | ethanol | 5.7 | 0.07 | 450 | 100 | 7.8 | 2.9 | 1.5 |
| | heptane | 5.4 | 0.10 | 380 | 150 | 6.6 | 1.8 | 0.9 |

### Control Example C

Control Example C was carried out according to the method of Example 41 with the exception that the treatment composition contained only ethanol. The liquid used for each injection, the initial pressure, the pressure change (ΔP), the flow rate for each injection, the amount of liquid used for each injection, the flow rate of gas through the core (Q), the gas permeability (K), and the improvement factor (PI) are shown in Table 7, above.

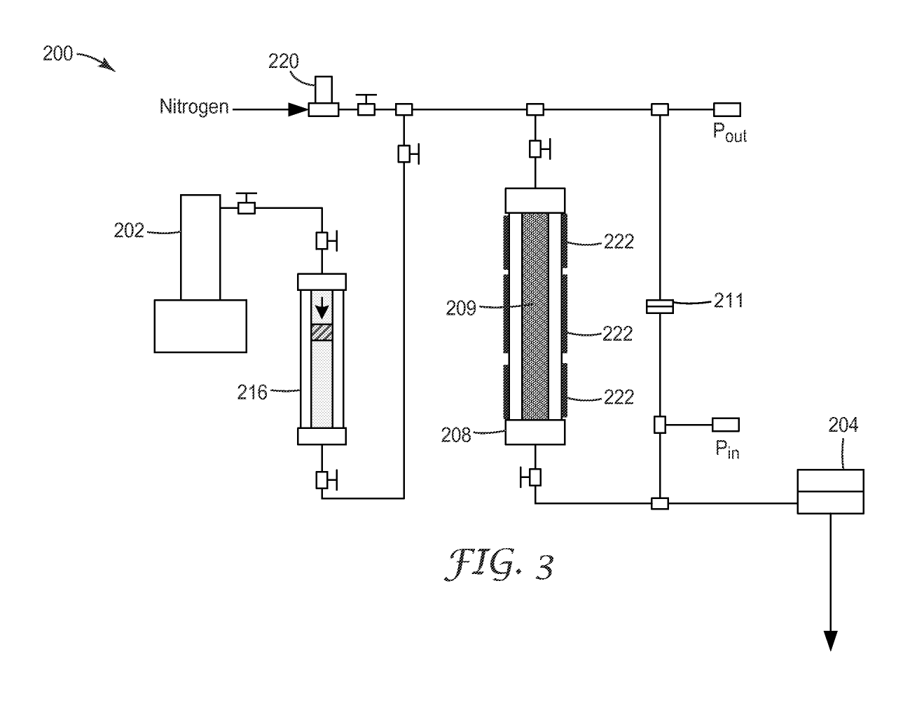

The results of the evaluations using sea sand or particulate calcium carbonate can be verified using core flood evaluations either on sandstone or limestone core samples. A schematic diagram of a core flood apparatus 200 that can be used is shown in FIG. 3. Core flood apparatus 200 includes positive displacement pump 202 (Model QX6000SS, obtained from Chandler Engineering, Tulsa, Okla.) to inject n-heptane at constant rate into fluid accumulators 216. Nitrogen gas can be injected at constant rate through a gas flow controller 220 (Model 5850 Mass Flow Controller, Brokks Instrument, Hatfield, Pa.). A pressure port 211 on high-pressure core holder 208 (Hassler-type Model RCHR-1.0 obtained from Temco, Inc., Tulsa, Okla.) can be used to measure pressure drop across the vertical core 209. A back-pressure regulator (Model No. BP-50; obtained from Temco, Tulsa, Okla.) 204 can be used to control the flowing pressure downstream of core 209. High-pressure core holder 208 can be heated with 3 heating bands 222 (Watlow Thinband Model STB4A2AFR-2, St. Louis, Mo.).

In a typical procedure, a core can be dried for 72 hours in a standard laboratory oven at 95° C. and then wrapped in aluminum foil and heat shrink tubing. Referring again to FIG. 3, the wrapped core 209 can placed in core holder 208 at the desired temperature. An overburden pressure of, for example, 2300 psig (1.6×10⁷ Pa) can be applied. The initial single-phase gas permeability can be measured using nitrogen at low system pressures between 5 to 10 psig (3.4×10⁴ to 6.9×10⁴ Pa).

Deionized water or brine can be introduced into the core 209 by the following procedure to establish the desired water saturation. The outlet end of the core holder is connected to a vacuum pump and a full vacuum can be applied for 30 minutes with the inlet closed. The inlet can be connected to a burette with the water in it. The outlet is closed and the inlet is opened to allow 2.1 mL of water to flow into the core. The inlet and the outlet valves can then be closed for the desired time. The gas permeability can be measured at the water saturation by flowing nitrogen at 500 psig (3.4×10⁶ Pa). The core holder 208 can then be heated to a higher temperature, if desired, for several hours. Nitrogen and n-heptane can be co-injected into the core at an average total flow rate in the core of, for example, 450 mL/hour at a system pressure of, for example, 900 psig (6.2×10⁶ Pa) until steady state is reached. The flow rate of nitrogen is controlled by gas flow controller 220, and the rate for n-heptane is controlled by positive displacement pump 202. The flow rates of nitrogen and n-heptane can be set such that the fractional flow of gas in the core was 0.66. The gas relative permeability before treatment can then be calculated from the steady state pressure drop. The treatment composition can then be injected into the core at a flow rate of, for example, 120 mL/hour for about 20 pore volumes. Nitrogen and n-heptane co-injection can be resumed at an average total flow rate in the core of, for example, 450 mL/hour at a system pressure of, for example, 900 psig (6.2×10⁶ Pa) until steady state is reached. The gas relative permeability after treatment can then be calculated from the steady state pressure drop.

### Example 42

### CF₃CFH—O—(CF₂)₅CH₂OC(O)NHCH₂CH₂CH₂Si(OCH₂CH₃)₃

### Part A

CF₃CFH—O—(CF₂)₅COOH (426 grams, 1.0 mole), which was prepared according to the method described in Example 3 of U.S. Pat. App. Pub. No. 2007/0276103, was esterified at 65° C. with methanol (200 grams, 6.3 moles) and concentrated sulfuric acid (200 grams, 2.0 moles). The reaction mixture was washed with water and distilled at 172° C. to give 383 grams of CF₃CFH—O—(CF₂)₅COOCH₃, which was combined with material from a repeat run and used in Part B.

### Part B

A 5-L round-bottom flask equipped with a mechanical stirrer and nitrogen bubbler was charged with 1 L of 1,2-dimethoxyethane and sodium borohydride (76 grams, 2.0 moles) and heated to 80° C. CF₃CFH—O—(CF₂)₅COOCH₃ (713 grams, 1.67 mole), prepared as described in Part A, was added to the stirred slurry over a period of one hour. A mixture of concentrated sulfuric acid (198 grams) and water (1.0 L) was added to the reaction mixture. The lower phase was separated, and the solvent was removed by distillation. Further distillation provided 506 grams of

CF₃CFH—O—(CF₂)₅CH₂OH (boiling point 173° C.), the structure of which was confirmed by Fourier Transform Infrared Spectroscopy (FTIR) and ¹H and ¹⁹F Nuclear Magnetic Resonance (NMR) Spectroscopy.

### Part C

A 100-mL flask equipped with a magnetic stirrer, thermometer, and condenser was charged with CF₃CFH—O—(CF₂)₅CH₂OH (3.98 grams, 10 mmol), 3-isocyanatopropyltriethoxysilane (2.47 grams, 10 moles), and ethyl acetate (15.05 grams) under a nitrogen atmosphere, and the mixture was stirred to give a homogeneous solution of about 30% by weight. Two drops of dibutyltin dilaurate were added, and the reaction mixture was heated at 60° C. for four hours under nitrogen using a heating mantle. Analysis by IR spectroscopy indicated no residual isocyanate was left.

### Example 43

### CF₃CFH—O—(CF₂)₃CH₂OC(O)NHCH₂CH₂CH₂Si(OCH₂CH₃)₃

### Part A

FC(O)CF(CF₃)—O—(CF₂)₃COF (503 grams, 1.4 mole), prepared as described in U.S. Pat. App. Pub. No. 2004/0116742, was added over a period of two hours to a stirred mixture of sodium carbonate (387 grams, 3.7 moles) and diglyme (650 grams) at 78° C. The reaction liberated carbon dioxide gas. Distilled water (35 grams, 1.9 mole) was added at 85° C., and then the reaction mixture was heated to 165° C. and maintained at that temperature for 30 minutes. The reaction was allowed to cool, and sulfuric acid (250 grams, 2.6 moles) in 1250 grams of water was added. Two layers formed, and the top layer was washed with 33% sulfuric acid and then esterified at 65° C. with methanol (200 grams, 6.3 moles) and concentrated sulfuric acid (200 grams, 2.0 moles). The reaction mixture was washed with water and distilled at 52° C. at 15 mmHg (2.0×10³ Pa) to give 258 grams of CF₃CFH—O—(CF₂)₃COOCH₃.

### Part B

CF₃—CFH—O—(CF₂)₃—CH₂—OH was prepared according to the method of Example 42, Part B, except 200 grams (0.6 mole) of CF₃—CFH—O—(CF₂)₃—C(O)O—CH₃ was reduced with 30 grams (0.79 mole) of sodium borohydride in 0.2 L of 1,2-dimethoxyethane. At the end of the reaction 150 grams of concentrated sulfuric acid in 0.3 L of water were added, and 115 grams of CF₃—CFH—O—(CF₂)₃—CH₂—OH, having a boiling point of 130° C., were obtained.

### Part C

CF₃CFH—O—(CF₂)₃CH₂OC(O)NHCH₂CH₂CH₂Si(OCH₂CH₃)₃ was prepared according to the method of Example 42 Part C except CF₃—CFH—O—(CF₂)₃—CH₂—OH was used instead of CF₃—CFH—O—(CF₂)₅—CH₂—OH.

### Examples 44 to 48

Each of Silane Examples 42 and 43 was combined with beta-(3,4-epoxycyclohexyl)ethyltrimethoxysilane (obtained from GE Silicones, Albany, N.Y., under the trade designation “A186”) or gamma-glycidoxypropyltrimethoxysilane (obtained from GE Silicones under the trade designation “A187” and a cationic photoinitiator obtained from Dow Chemical, Midland, Mich., under the trade designation “UVI 6976” in the amounts shown in Table 8, below. Each formulation was coated with a #6 wire-wound coating bar (obtained from RD Specialties, Webster, N.Y.) onto primed side of PET film obtained from E. I. DuPont de Nemours and Co., Wilmington, Del. under the trade designation “MELINEX 618”. Each sample was photocured under the irradiation of two Sylvania Germicidal G15T8 (15W) bulbs in the air for 2 minutes.

Advancing, receding, and static contact angles on the PET were measured using a CAHN Dynamic Contact Angle Analyzer, Model DCA 322 (a Wilhelmy balance apparatus equipped with a computer for control and data processing, obtained from ATI, Madison, Wis.). Water and hexadecane were used as probe liquids, and the average of 3 measurements are reported in Table 8, below.

TABLE 8

| | | Contact angle vs. | | | Contact angle vs. | | |
|---|---|---|---|---|---|---|---|
| | | water | | | hexadecane | | |
| Example | Formulation | Adv | Rec | Static | Adv | Rec | Static |
| 44 | “A186” + 5% Ex. 43 | 86.2 | 59.2 | 76.5 | 35.7 | 10.9 | 39.0 |
| 45 | “A186” + 5% Ex. 42 | 96.2 | 67.7 | 83.6 | 47.1 | 29.2 | 48.0 |
| 46 | “A186” + 2.5% Ex. 42 | 94.1 | 66.2 | 74.5 | 37.8 | 16.7 | 42.0 |
| control | “A186”/“UVI 6976” | 77.8 | 45.2 | 67.5 | 11.8 | 5.2 | 11.2 |
| | (92/8) | | | | | | |
| 47 | “A187” + 10% Ex. 43 | 93.1 | 55.3 | 90.5 | 48.8 | 14.8 | 42.0 |
| 48 | “A187” + 10% Ex. 42 | 103.3 | 61.5 | 94.1 | 57.3 | 29.2 | 57.4 |
| control | “A187”/“UVI 6976” | 52.9 | 38.3 | 52.5 | 8.8 | 4.3 | 11.3 |
| | (92/8) | | | | | | |

### Examples 49 to 53

Examples 49 to 53 were prepared according to the method of Examples 44 to 48 except using the substrates shown in Table 9, below. Contact angles were measured versus water and hexadecane, and the results are shown in Table 9, below.

TABLE 9

| | | | Contact angle vs. | | | Contact angle vs. | | |
|---|---|---|---|---|---|---|---|---|
| | | | water | | | hexadecane | | |
| Example | Formulation | Substrate | Adv | Rec | Static | Adv | Rec | Static |
| 49 | “A187” + 10% Ex. 43 | Glass | 91.0 | 50.6 | 81.8 | 45.6 | 22.5 | 43.3 |
| 50 | “A187” + 15% Ex. 43 | Glass | 97.3 | 58.0 | 84.2 | 56.0 | 26.9 | 48.3 |
| 51 | “A187” + 10% Ex. 42 | Glass | 101.4 | 63.2 | 91.0 | 51.1 | 33.6 | 48.4 |
| control | “A187”/“UVI 6976” | Glass | 79.4 | 40.4 | 69.4 | 11.7 | NM | 5.9 |
| | (92/8, Control) | | | | | | | |
| 52 | “A187” + 10% Ex. 42 | PC film | 101.3 | 62.4 | 91.1 | 61.6 | 16.3 | 57.4 |
| 53 | “A187” + 10% Ex. 42 | SS | 99.9 | 65.9 | 95.3 | 59.7 | 24.0 | 60.1 |

Various modifications and alterations of this disclosure may be made by those skilled in the art without departing from the scope and spirit of this disclosure, and it should be understood that this disclosure is not to be unduly limited to the illustrative embodiments set forth herein.

1. A fluorinated compound represented by formula:
Rf-Q-X—[Si(R)_{f}(R¹)_{3-f}]_{g}
wherein
Rf is selected from the group consisting of:
Rf^{a}-(O)ᵣ-CHF—(CF₂)ₙ-;
[Rf^{b}-(O)ₜ-C(L)H—CF₂—O]ₘ-W—;
CF₃CFH—O—(CF₂)ₚ-;
CF₃—(O—CF₂)_{z}-; and
CF₃—O—(CF₂)₃—O—CF₂—;
Q is selected from the group consisting of a bond, —C(O)—N(R²)—, and —C(O)—O—, wherein R² is selected from the group consisting of hydrogen and alkyl having from 1 to 4 carbon atoms;
X is selected from the group consisting of alkylene and arylalkylene, wherein alkylene and arylalkylene are each optionally interrupted by at least one functional group independently selected from the group consisting of ether, amine, ester, amide, carbamate, and urea and optionally substituted by hydroxyl;
Rf^{a} and Rf^{b} independently represent a partially or fully fluorinated alkyl group having from 1 to 10 carbon atoms and optionally interrupted with at least one oxygen atom;
L is selected from the group consisting of F and CF₃;
W is selected from the group consisting of alkylene and arylene;
R is selected from the group consisting of alkyl, aryl, arylalkylenyl, and alkylarylenyl;
R¹ is selected from the group consisting of halide, hydroxyl, alkoxy, aryloxy, acyloxy, and polyalkyleneoxy, wherein alkoxy and acyloxy are optionally substituted by halogen, and wherein aryloxy is optionally substituted by halogen, alkyl, or haloalkyl;
f is 0 or 1;
g is a value from 1 to 2;
r is 0 or 1, wherein when r is 0, then Rf^{a} is interrupted with at least one oxygen atom;
t is 0 or 1;
m is 1, 2, or 3;
n is 0 or 1;
each p is independently a number from 1 to 6; and
z is a number from 2 to 7.

2. The fluorinated compound according to claim 1, wherein Rf is selected from the group consisting of:
Rf^{a}-(O)ᵣ-CHF—(CF₂)ₙ-;
[Rf^{b}-(O)ₜ-C(L)H—CF₂—O]ₘ-W—; and
CF₃CFH—O—(CF₂)ₚ-.

3. The fluorinated compound according to claim 1, wherein t and r are each 1, and wherein Rf^{a} and Rf^{b} are independently selected from the group consisting of:
fully fluorinated aliphatic groups having from 1 to 6 carbon atoms; and
fully fluorinated groups represented by formula:
R_{f}¹—[OR_{f}²]ₓ-[OR_{f}³]_{y}-,
wherein
R_{f}¹ is a perfluorinated aliphatic group having from 1 to 6 carbon atoms;
R_{f}² and R_{f}³ are each independently perfluorinated alkylene having from 1 to 4 carbon atoms; and
x and y are each independently a number from 0 to 4, wherein the sum of x and y is at least 1.

4. The fluorinated compound according to claim 1, wherein t and r are each 0, and wherein R_{f}^{a} and Rf^{b} are independently a fully fluorinated group represented by formula:
R_{f}⁴—[OR_{f}⁵]ₐ-[OR_{f}⁶]_{b}-O—CF₂—,
wherein
R_{f}⁴ is a perfluorinated aliphatic group having from 1 to 6 carbon atoms;
R_{f}⁵ and R_{f}⁶ are each independently perfluorinated alkylene having from 1 to 4 carbon atoms; and
a and b are each independently numbers from 0 to 4.

5. The fluorinated compound according to claim 1, wherein Rf is selected from the group consisting of:
C₃F₇—O—CHF—;
CF₃—O—CF₂CF₂—CF₂—O—CHF—;
CF₃CF₂CF₂—O—CF₂CF₂—CF₂—O—CHF—;
CF₃—O—CF₂—CF₂—O—CHF—;
CF₃—O—CF₂—O—CF₂—CF₂—O—CHF—;
CF₃—(O—CF₂)₂—O—CF₂—CF₂—O—CHF—;
CF₃—(O—CF₂)₃—O—CF₂—CF₂—O—CHF—;
CF₃—O—CHF—CF₂—;
CF₃—O—CF₂—CF₂—O—CHF—CF₂—;
CF₃—CF₂—O—CHF—CF₂—;
CF₃—CF₂—CF₂—O—CHF—CF₂—;
CF₃—O—CF₂—CF₂—CF₂—O—CHF—CF₂—;
CF₃—O—CF₂—O—CF₂—CF₂—O—CHF—CF₂—;
CF₃—(O—CF₂)₂—O—CF₂—CF₂—O—CHF—CF₂—;
CF₃—(O—CF₂)₃—O—CF₂—CF₂—O—CHF—CF₂—;
CF₃—O—CF₂—CHF—;
C₃F₇—O—CF₂—CHF—;
CF₃—O—CF₂—CF₂—CF₂—O—CF₂—CHF—;
CF₃—O—CF₂—O—CF₂—CF₂—O—CF₂—CHF—;
CF₃—(O—CF₂)₂—O—CF₂—CF₂—O—CF₂—CHF—;
CF₃—(O—CF₂)₃—O—CF₂—CF₂—O—CF₂—CHF—;
CF₃—O—CF₂—CHF—CF₂—;
C₂F₅—O—CF₂—CHF—CF₂—;
C₃F₇—O—CF₂—CHF—CF₂—;
CF₃—O—CF₂—CF₂—CF₂—O—CF₂—CHF—CF₂—;
CF₃—O—CF₂—O—CF₂—CF₂—O—CF₂—CHF—CF₂—;
CF₃—(O—CF₂)₂—O—CF₂—CF₂—O—CF₂—CHF—CF₂—;
and
CF₃—(O—CF₂)₃—O—CF₂—CF₂—O—CF₂—CHF—CF₂—.

6. The fluorinated compound according to claim 5, wherein Rf is selected from the group consisting of CF₃—O—CF₂CF₂—CF₂—O—CHF—; CF₃—O—CF₂—CF₂—CF₂—O—CF₂—CHF—; CF₃—O—CF₂—CF₂—CF₂—O—CHF—CF₂—; and CF₃—O—CF₂—CF₂—CF₂—O—CF₂—CHF—CF₂—.

7-10. (canceled)

11. The fluorinated compound according to claim 1, wherein Rf is CF₃—O—(CF₂)₃—O—CF₂—.

12. The fluorinated compound according to claim 1, wherein Q is —C(O)—N(R²)—, wherein X is alkylene having up to 8 carbon atoms, and wherein X is optionally interrupted by at least one functional group independently selected from the group consisting of ether and carbamate.

13. A composition comprising solvent, the fluorinated compound according to claim 1 and a compound represented by formula:
(R)_{q}M(R¹)_{r′-q}
wherein
R is selected from the group consisting of alkyl, aryl, arylalkylenyl, and alkylarylenyl;
M is selected from the group consisting of Si, Ti, Zr, and Al,
R¹ is selected from the group consisting of halide, hydroxyl, alkoxy, aryloxy, aryloxy, and polyalkyleneoxy;
r′ is 3 or 4; and
q is 0, 1, or 2.

14. (canceled)

15. A composition comprising the compound according to claim 1 and solvent.

16. The composition according to claim 15, further comprising at least one of acetic acid, citric acid, formic acid, para-toluenesulfonic acid, triflic acid, perfluorobutyric acid, hydroboric acid, sulfuric acid, phosphoric acid, or hydrochloric acid.

17-19. (canceled)

20. A method comprising contacting a hydrocarbon-bearing formation with a composition according to claim 15.

21. The method according to claim 20, wherein the hydrocarbon-bearing formation comprises at least one of sandstone, shale, conglomerate, diatomite, or sand.

22. (canceled)

23. The method according to claim 20, wherein the hydrocarbon-bearing formation has at least one fracture, and wherein the fracture has a plurality of proppants therein.

24. The method according to claim 20, wherein the solvent comprises at least one of water, a monohydroxy alcohol, a glycol, an ether, a glycol ether, a ketone, or supercritical carbon dioxide, wherein the monohydroxy alcohol, glycol, ether, and ketone each independently have up to 4 carbon atoms, and wherein the glycol ether has up to 9 carbon atoms.

25. The method according to claim 20, wherein before contacting the hydrocarbon-bearing formation with the composition, the hydrocarbon-bearing formation has at least one of brine or liquid hydrocarbons, and wherein the hydrocarbon-bearing formation has at least a gas permeability that is increased after it is contacted with the composition.

26. The method according to claim 25, further comprising contacting the hydrocarbon-bearing formation with a fluid before contacting the hydrocarbon-bearing formation with the composition, wherein the fluid at least one of at least partially solubilizes or partially displaces at least one of the brine or liquid hydrocarbons in the hydrocarbon-bearing formation.

27. An article comprising a surface, wherein at least a portion of the surface is treated with a siloxane, the siloxane comprising at least one condensation product of the fluorinated compound according to claim 1.

28. The article according to claim 27, wherein the siloxane is covalently bonded to the surface.

29-30. (canceled)

31. The article according to claim 27, wherein the article is a hydrocarbon-bearing formation or a proppant particle.
